(19) United States
(12) Patent Application Publication
(10) Pub. No.: US 2026/0355867 A1
(43) Pub. Date: Nov. 12, 2026

(54) WELD CURTAIN FOR USE WITH WELD TOP AND METHOD OF USE

(71) Applicant: FLEXTUR CORP., Dalton, OH (US)

(72) Inventor: Larry Weaver, Dalton, OH (US)

(73) Assignee: FLEXTUR CORP., Dalton, OH (US)

(21) Appl. No.: 19/200,001

(22) Filed: May 6, 2025

(51) Int. Cl. B23K 37/006

(52) U.S. Cl. CPC B23K 37/006

(57) ABSTRACT

A weld curtain may include a screen, a frame, and a linear post that may engage with the frame and rotatably engage with the weld curtain. The weld curtain may include a first support and a second support, and the supports may be inserted into a first sleeve and a second sleeve and engaging the supports with one another to create the frame. The frame and the screen may be supported by the linear post and may be cantilevered from a weld table by the linear post. The weld curtain may rotate about a dowel inserted in the weld table or may rotate about an extension that may be inserted into a bracket that is engaged with the weld table. The weld curtain of the present disclosure may provide a way to promote safety for users and allow for easier transport to and from different weld stations if needed.

### TECHNICAL FIELD

This disclosure is directed generally to weld curtains, weld screens, and weld shields.

### BACKGROUND ART

Weld curtains or weld screens are used in the welding industry as a safety device to protect workers from sparks and heat during the welding process. Weld curtains are typically made from fire-resistant materials and are designed to withstand high temperatures. The purpose of a weld curtain is to protect workers and other equipment from the process of welding.

Currently, welding curtains are very large and cumbersome in the workplace. There are various types of weld curtains available such as a large weld curtain on wheels that may be moved throughout a workplace, or permanent weld curtains that surround a specific workstation and that weld curtain protects that workstation only. People working near welding devices that may need to drop things off at a welding statement may not wear protection because they are not actively welding and the large curtains that are floor models do not allow for protection to those who are dropping things off at a weld station because the worker would have to walk around the large floor model weld curtain to drop the materials off to the person who is welding.

### SUMMARY OF THE INVENTION

The new inventive device provides for a small pivotable welding curtain designed to protect workers while allowing those not actively welding but that need to go near the table protection as well. In one aspect, an exemplary embodiment of the present disclosure may provide a weld curtain comprising: a screen; a frame having at least one support configured to support a portion of the screen; and a linear post operably engaged with the frame and is adapted to rotatably engage the weld curtain to a weld table.

In another aspect, an exemplary embodiment of the present disclosure may provide the weld curtain, wherein the frame and the screen are fully supported by the linear post and wherein the frame and the screen are collectively cantilevered from the weld table by the linear post. The weld curtain, wherein the at least one support further comprises: a first support that is configured to be received by a first sleeve of the screen; a second support that is configured to be received by a second sleeve of the screen; wherein the first support and the second support are perpendicular to one another; and wherein the first support and the second support operably engage with one another. The weld, wherein the at least one support further comprises: a first support that is configured to be received by a first sleeve of the screen; a second support that is configured to be received by a second sleeve of the screen; and wherein the first support and the second support are parallel to one another. The weld curtain, further comprising a third support, wherein the third support operably engages with the first support and the second support. The weld curtain further comprising: a first sleeve located at a first position on the screen and configured to receive the first support of the pair of supports; a second sleeve located at a second position on the screen and configured to receive the second support; and a third sleeve located at a third position on the screen that is configured to receive the third support of the frame. The weld curtain, wherein the third support comprises: a first end that is configured to receive and engage with a first portion of the first support; and a second end that is configured to receive and engage with a first portion of the second support. The weld curtain, further comprising: a first securement mechanism releasably engaging the first end of the third support and the first portion of the second support with one another and a second securement mechanism releasably engaging the second end of the third support and the first portion of the first support with one another. The weld curtain, further comprising a fourth support that operably engages with the first support and the second support. The weld curtain, wherein the fourth support comprises: a first end that is operably engaged with a second portion of the first support, and a second end that is operably engaged with a second portion of the second support, wherein the fourth support is parallel to the third support. The weld curtain, wherein the second support has a length within a range of about 26 inches to about 46 inches, wherein the second support is perpendicular to the first support. The weld curtain, wherein the first support has a height within a range of about 12 inches to about 32 inches, and wherein the second support has a height within a range of about 12 inches to about 32 inches, wherein the first support and second support are parallel to one another. The weld curtain, further comprising: a connector configured to receive the linear post and adapted to engaged with a leg of the weld table. The weld curtain, wherein the connector further comprises: at least one lug of a bracket; and an aperture defined in the at least one lug of the bracket configured to receive the linear post. The weld curtain, wherein the bracket further comprises: a main body operably engaging with the bracket and being generally L-shaped; and a corner bracket operably engaged with the main body and adapted to receive a corner of the leg of the weld table.

In one aspect, an exemplary embodiment of the present disclosure may provide a method of assembling a weld curtain comprising: inserting a first support, into a first sleeve of the screen, the first support having a first end and a second end; inserting a second support into a second sleeve of the screen, the second support having a first end and a second end; engaging a dowel with the second end of the first support; and inserting the dowel into an opening on a weld table, wherein the weld curtain is fully supported by the dowel.

In another aspect, an exemplary embodiment of the present disclosure may provide the method, wherein the steps of inserting the first support into the first sleeve and inserting the second support into the second support further include that the first support and the second support are oriented parallel to one another or oriented perpendicular to one another. The method, further comprising: inserting a third support into a third sleeve of the screen; engaging the first end of the first support with the third support inside of a channel of the third support; and engaging the first end of the second support with the third support inside of the channel of the third support; engaging a fourth support to the second end of the first support; and engaging the fourth support to the second end of the second support. The method, further comprising: rotating the weld curtain, by the dowel, about a rotational axis defined along a length of the dowel when the dowel is inserted into the opening of the weld table.

In one aspect, an exemplary embodiment of the present disclosure may provide a method of assembling a weld curtain comprising: inserting a first support, into a first sleeve of the screen, the first support having a first end and a second end; inserting a second support into a second sleeve of the screen, the second support having a first end and a second end, wherein the second end further comprises an extension; engaging a first end of the connector with a leg of the weld table; engaging the extension with a second end of the connector; and rotating the weld curtain, by the extension, about a rotational axis defined along the length of the extension relative to the weld table.

In another aspect, an exemplary embodiment of the present disclosure may provide the method, further comprising: inserting the extension into an aperture of at least one lug of a bracket of the connector. The method, further comprising: engaging a corner bracket of the connector with a leg of the weld table. The method, further comprising: engaging a bolt with the extension and the connector so that the bolt and extension are fixedly engaged.

In another aspect, an exemplary embodiment of the present disclosure may provide a method of dissembling a weld curtain comprising: removing a dowel from an opening in a weld table; removing a third bolt having a length that extends through an aperture of the dowel and into a second aperture at a second end of a second upright support of a pair of upright supports; removing the dowel from a frame of the weld curtain; removing a crossbar from the pair of upright supports; loosening a first nut; removing a first bolt from a first end of a first upright support of the pair of upright supports and from a first end of the crossbar; removing the first upright support of the pair of upright supports from a channel of the crossbar; loosening a second nut; removing a second bolt from a first end of the second upright support of the pair of upright supports and removing the second bolt from a second end of the crossbar; removing the second upright support of the pair of upright supports from the channel of the crossbar; sliding the first upright support out of a first side sleeve of a screen of the weld curtain; sliding the second upright support out of a second side sleeve of the screen of the weld curtain; sliding the crossbar out of a top sleeve of the screen of the weld curtain; and placing all materials of the weld curtain away.

In another aspect, an exemplary embodiment of the present disclosure may provide A weld curtain may include a screen, a frame, and a linear post that may engage with the frame and rotatably engage with the weld curtain. The weld curtain may include a first support and a second support, and the supports may be inserted into a first sleeve and a second sleeve and engaging the supports with one another to create the frame. The frame and the screen may be supported by the linear post and may be cantilevered from a weld table by the linear post. The weld curtain may rotate about a dowel inserted in the weld table or may rotate about an extension that may be inserted into a bracket that is engaged with the weld table. The weld curtain of the present disclosure may provide a way to promote safety for users and allow for easier transport to and from different weld stations if needed.

In another aspect, an exemplary embodiment of the present disclosure may provide a weld curtain may include a screen, a frame, and a linear post that may engage with the frame and rotatably engage with the weld curtain. The weld curtain may include a first support and a second support, and the supports may be inserted into a first sleeve and a second sleeve and engaging the supports with one another to create the frame. The frame and the screen may be supported by the linear post and may be cantilevered from a weld table by the linear post. The weld curtain may rotate about a dowel inserted in the weld table or may rotate about an extension that may be inserted into a bracket that is engaged with the weld table. The weld curtain of the present disclosure may provide a way to promote safety for users and allow for easier transport to and from different weld stations if needed.

### BRIEF DESCRIPTION OF THE DRAWINGS

One or more exemplary embodiment(s) of the present disclosure is set forth in the following description, is shown in the drawings and is particularly and distinctly pointed out and set forth in the appended claims. The accompanying drawings, which are incorporated in and constitute a part of the specification, illustrate various example configurations and methods, and other example embodiments of various aspects of the invention. It will be appreciated that the illustrated element boundaries (e.g., boxes, groups of boxes, or other shapes) in the figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

FIG. 1 (FIG. 1) is an operational view of a weld curtain being used during a welding process depicting a first embodiment.

FIG. 2 (FIG. 2) is an environmental front elevation view of the weld curtain.

FIG. 3 (FIG. 3) is an environmental rear elevation view of the weld curtain.

FIG. 4A (FIG. 4A) is an enlargement view of the highlighted region shown in FIG. 2 illustrating a first end of a top crossbar and a first end of a first post.

FIG. 4B (FIG. 4B) is an exploded view of the first end of the top crossbar and the first end of the first post shown in FIG. 4A.

FIG. 5A (FIG. 5A) is an enlargement view of the highlighted region shown in FIG. 2 illustrating a second end of the top crossbar and a first end of a second post.

FIG. 5B (FIG. 5B) is an exploded view of the second end of the top crossbar and the first end of the second post shown in FIG. 5A.

FIG. 6A (FIG. 6A) is an enlargement view of the highlighted region shown in FIG. 2 illustrating a first end of a bottom crossbar and a second end of the first post.

FIG. 6B (FIG. 6B) is an exploded view of the first end of the bottom crossbar and the second end of the first post shown in FIG. 6A.

FIG. 7A (FIG. 7A) is an enlargement view of a second end of a bottom crossbar with a dowel and a second end of the second post.

FIG. 7B (FIG. 7B) is an exploded view of the second end of the bottom crossbar with the dowel and the second end of the second post shown in FIG. 7A.

FIG. 8 (FIG. 8) is an operational view of a dowel on the weld curtain being inserted into a weld table.

FIG. 9 (FIG. 9) is an operational view of the weld curtain rotating about the weld table.

FIG. 10 (FIG. 10) is a disassembled view of the weld curtain and the pieces of the weld curtain of the first embodiment shown in FIG. 2.

FIG. 11 (FIG. 11) is an operational view of another weld curtain being used during the welding process depicting a second embodiment.

FIG. 12A (FIG. 12A) is an enlargement view of the highlighted region shown in FIG. 11 illustrating a second end of a top crossbar and a first end of a second rod.

FIG. 12B (FIG. 12B) is an exploded view of the first end of the top crossbar and the first end of the second rod shown in FIG. 12A.

FIG. 13A (FIG. 13A) is an enlargement view of the highlighted region shown in FIG. 11 illustrating a second end of a bottom crossbar with a dowel and a second end of the second rod.

FIG. 13B (FIG. 13B) is an exploded view of the second end of the bottom crossbar with the dowel and the second end of the second rod shown in FIG. 13A.

FIG. 14A (FIG. 14A) is an enlargement view of the highlighted region shown in FIG. 11 illustrating a first end of the top cross bar and a first end of a first rod.

FIG. 14B (FIG. 14B) is an exploded view of the first end of the top crossbar and the first end of the first rod shown in FIG. 14A

FIG. 15A (FIG. 15A) is an enlargement view of the highlighted region shown in FIG. 11 illustrating a second end of the bottom crossbar and a second end of the first rod.

FIG. 15B (FIG. 15B) is an exploded view of the first end of the bottom crossbar and the second end of the first rod shown in FIG. 15A.

FIG. 16 (FIG. 16) is an operational view of a weld curtain being used during a welding process depicting a third embodiment.

FIG. 17 (FIG. 17) is an elevation view of a bracket configured to connect the weld curtain to a weld table.

FIG. 18A (FIG. 18A) is an exploded view of a second end of a bottom crossbar and a second end of a second rod.

FIG. 18B (FIG. 18B) is an exploded view of parts to connect the bracket to the weld curtain.

Similar numbers refer to similar parts throughout the drawings.

### DETAILED DESCRIPTION

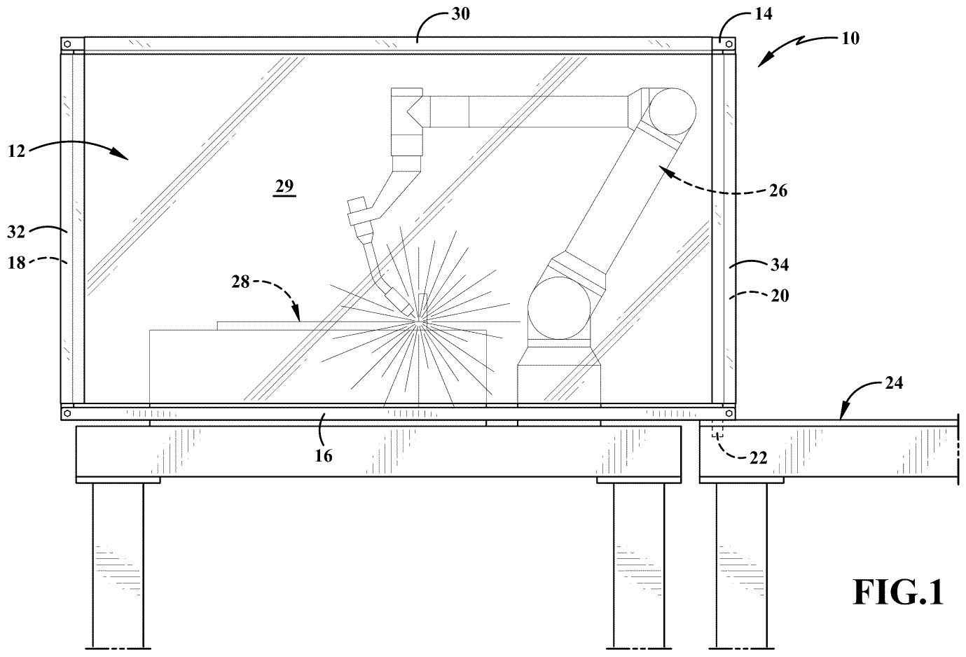

A weld curtain according to various aspects of the present disclosure is depicted throughout FIGS. 1-18B. A first embodiment is shown generally as 10. Weld curtain 10 is an improved way to protect workers from the dangers of welding. Weld curtain 10 provides, amongst other benefits, additional safety features for those within a workspace that are not actively welding, but that may be delivering items to a weld station. Additionally, weld curtain 10 provides flexibility to a workstation by its small design and/or footprint, capable of engaging with a tabletop or bench of conventional weld tables, and prevent a walking hazard like the large weld curtains that are currently used. The weld curtain 10 also allows for safety during welding and a safer work environment for those around the welding. Further, the weld curtain 10 may be disassembled and easily moved between different stations if needed and it is easily carried because of its size. This also allows for small containers for shipping and overall, more ease from shipping the weld curtain 10 to using the weld curtain 10. Such components that form the weld curtain 10 are now described in greater below.

FIG. 1 depicts the weld curtain 10 that includes a screen 12, a top crossbar 14, a bottom crossbar 16, a first post 18, a second post 20, and a dowel 22. The weld curtain 10 works in conjunction with a weld table 24, a cobot 26, and welded material 28. The top crossbar 14, the bottom crossbar 16, the first post 18, and the second post 20 collectively define, when assembled together, a frame that carries or otherwise supports the screen 12 to form the weld curtain 10.

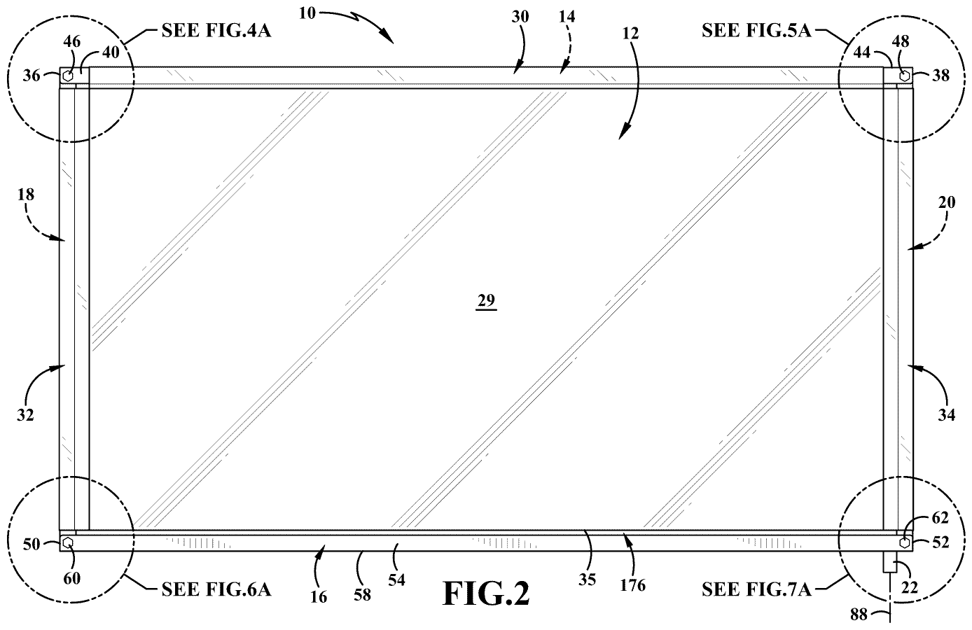

FIG. 2 depicts the screen 12, where screen 12 is generally rectangular in shape. Screen 12 may have a viewing screen 29 that is the main body of screen 12. Screen 12 may include a top sleeve 30, a first side sleeve 32, and a second side sleeve 34. In one exemplary embodiment the screen 12 may be a green semitransparent weld curtain. The top sleeve 30 is adjacent to both the first side sleeve 32 and the second side sleeve 34, where the first side sleeve 32 and the second side sleeve 34 are parallel to one another and on opposite sides of the screen 12. Top sleeve 30 is generally longer than both first side sleeve 32 and second side sleeve 34, but first side sleeve 32 and second side sleeve 34 are substantially equal in length. Screen 12 may further have a bottom edge 35 wherein the bottom edge 35 extends from first side sleeve 32, across viewing screen 29, and extending to second side sleeve 34. In another exemplary embodiment, there may be a bottom sleeve which would be opposite of top sleeve 30. Top sleeve 30, first side sleeve 32, and second side sleeve 34 are located around a perimeter of the screen 12, which is a generally rectangular shape. Top sleeve 30 extends fully along the length of the screen 12, while first side screen 32 and second side screen 34 extend fully along the height of the screen 12. In another exemplary embodiment, screen 12 may include a plurality of loops extending from each edge of the screen 12 rather than having a solid, single sleeve as discussed previously.

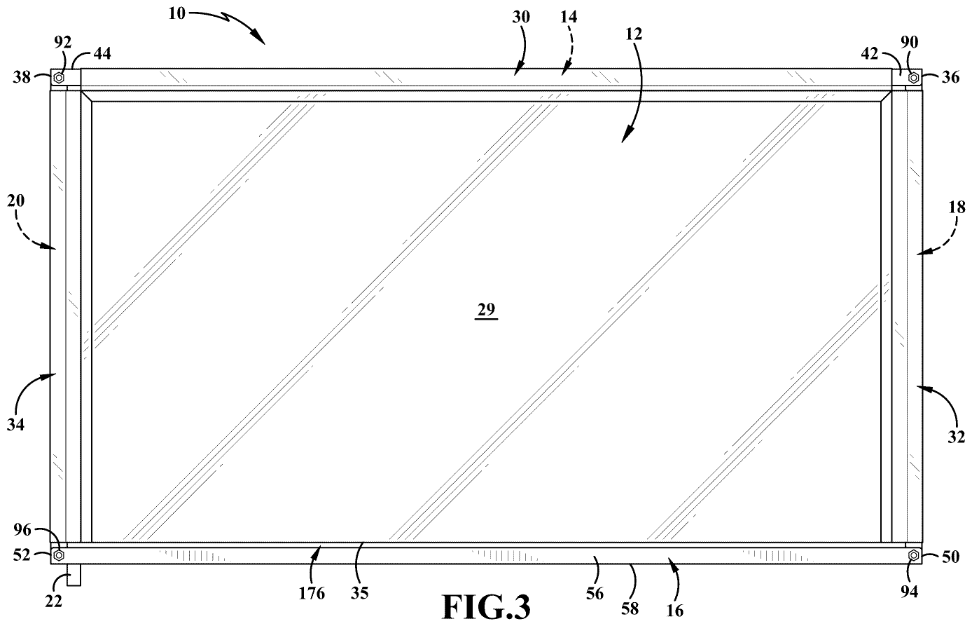

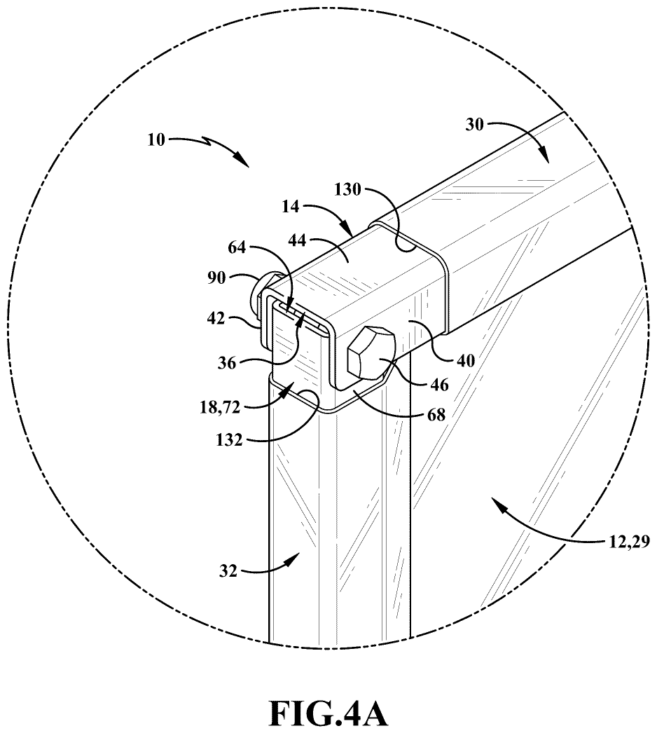

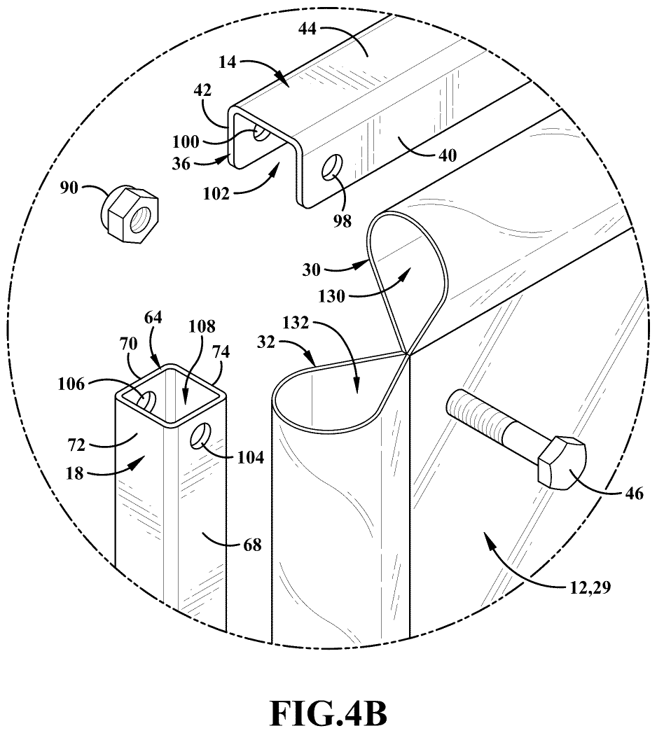

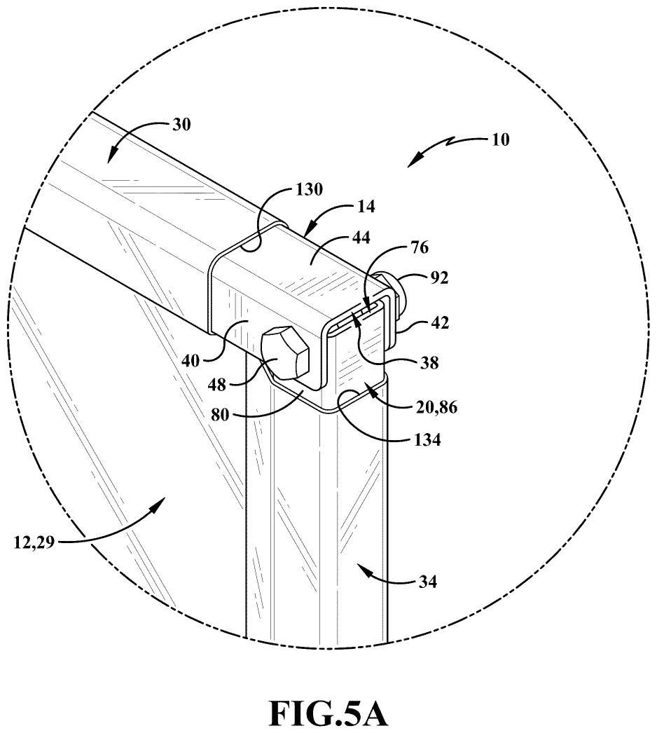

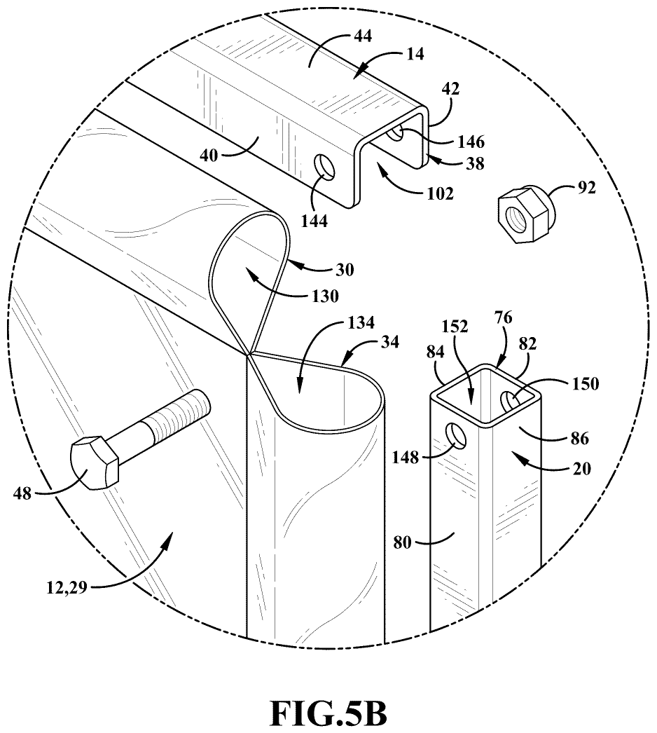

FIG. 2 further depicts the top crossbar 14 of weld curtain 10 having a first end 36, a second end 38 opposite to the first end 36 (see FIG. 3), and a lengthwise axis extending between the first end 36 and the second end 38. Top crossbar 14 may have a front wall 40 and a rear wall 42, as best seen in FIG. 4A, that are connected by a top wall 44. With such structural configuration, the top crossbar 14 defines a generally downward facing U-shaped cross-section creating a downward facing U-shaped channel therein. The purpose of top crossbar 14 having walls that define a channel may be to save weight for easier use and movement for the end user and to save weight in shipping costs. First end 36 of the top crossbar 14 may also be configured to engage with a first bolt 46 for assembly purposes, which will be described in more detail below. Second end 38 of the top crossbar 14 may also be configured to engage with a second bolt 48 which will be described in more detail in FIG. 5A and FIG. 5B.

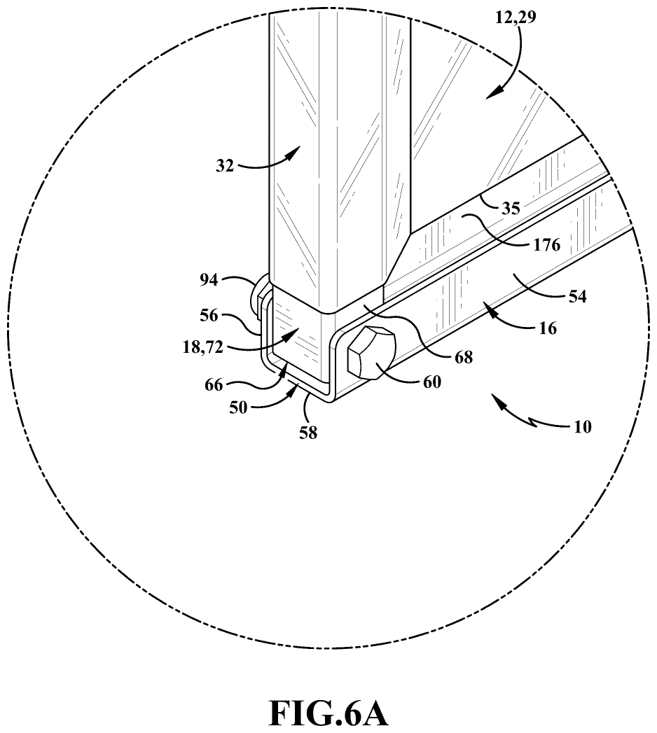

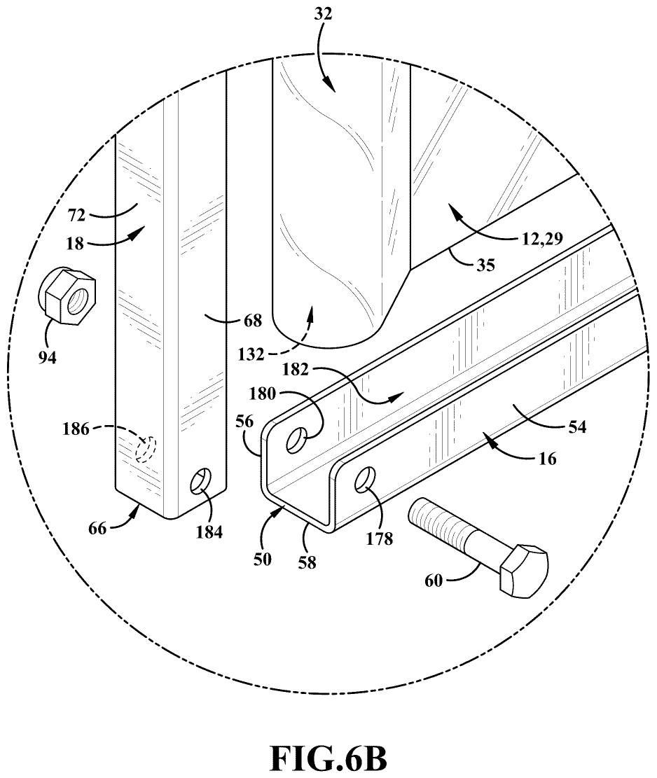

FIG. 2 further depicts the bottom crossbar 16 having a first end 50, a second end 52 opposite to the first end 50 (see FIG. 3), and a lengthwise axis extending between the first end 50 and the second end 52. Bottom crossbar 16 may also have a front wall 54 and a rear wall 56, best seen in FIG. 6A, where the front wall 54 and the rear wall 56 are connected by a bottom wall 58. The bottom crossbar 16 also defines a generally upward facing U-shaped cross-section creating a generally upward facing U-shaped channel therein. The purpose of bottom crossbar 16 having walls that define a channel may be to save weight for easier use and movement for the end user, and to save weight in shipping costs. First end 50 of the bottom crossbar may be configured to engage with a third bolt 60 for assembly purposes, which will be described in more detail below. Second end 52 of the bottom crossbar 16 may also be configured to engage with a fourth bolt 62 for assembly purposes, which will be described in more detail below. Further, the second end 52 of the bottom crossbar 16 includes the dowel 22 having an axis 88 extending longitudinally through the dowel 22, which will be discussed in further detail herein.

Upon assembly of weld curtain 10, top sleeve 30 of screen 12 receives the top crossbar 14. Top sleeve 30 extends the majority of the length of the top crossbar 14 but top crossbar 14 may have a greater length than the top sleeve 30 of screen 12. Top crossbar 14 and bottom crossbar 16 are substantially equal in length and width and are also substantially parallel to one another. In the present disclosure, the bottom crossbar 16 sits just below the bottom of screen 12 but still provides protection and a safe work environment for those that are positioned behind the weld curtain 10 when a welding operation is occurring.

Referring to FIGS. 4A and 6A, first post 18 has a first end 64, a second end 66 opposite to the first end 64, and a longitudinal axis extending between the first end 64 and the second end 66. First post 18 also has a front wall 68 and a rear wall 70 (see FIG. 4B) spaced apart by a first side wall 72 and a second side wall 74. Front wall 68 and rear wall 70 are opposite to one another, and front wall 68 is orthogonal to first side wall 72 and second side wall 74 while rear wall 70 is also orthogonal to first side wall 72 and second side wall 74.

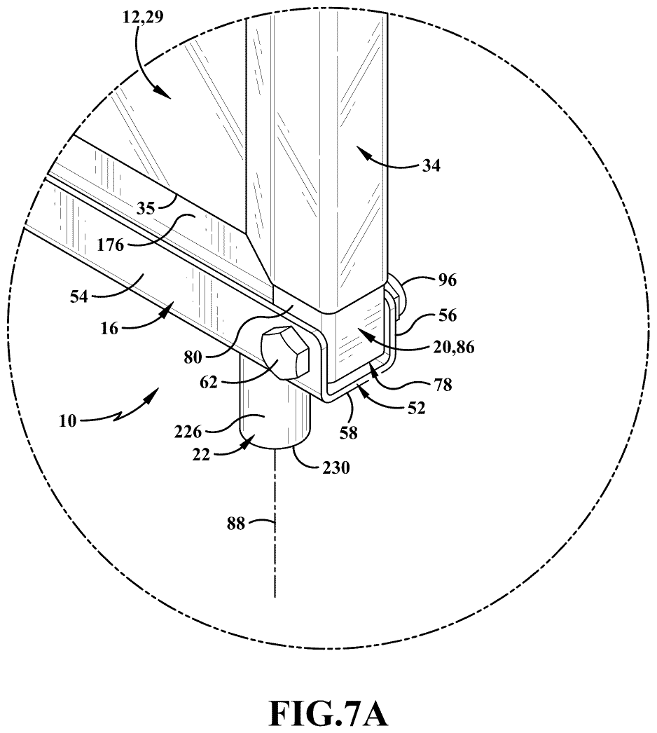

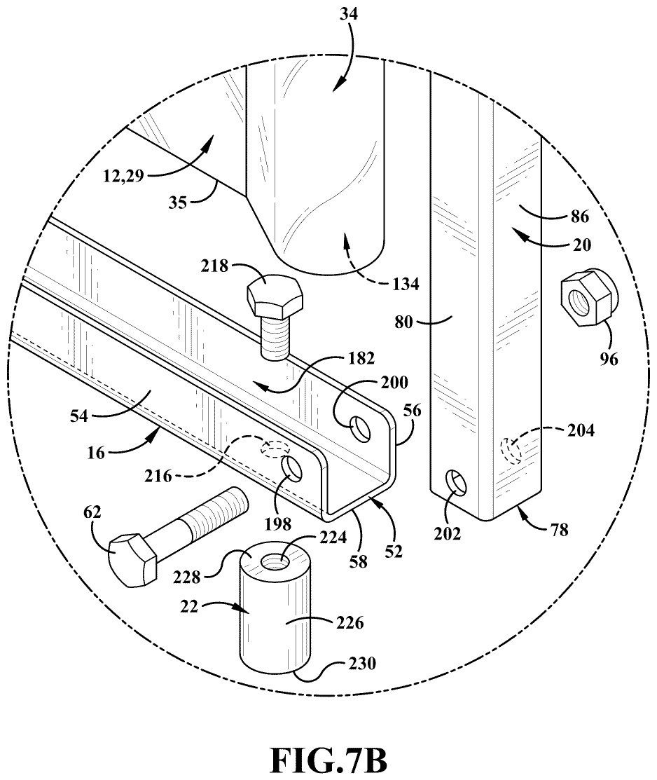

Referring to FIGS. 5A and 7A, second post 20 has a first end 76, a second end 78 that is opposite to the first end 76, and a longitudinal axis extending between the first end 76 and the second end 78. Second post 20 has a front wall 80 and a rear wall 82 spaced apart by a first side wall 84 and a second side wall 86. Front wall 80 and rear wall 82 are opposite to one another, and front wall 80 is orthogonal to first side wall 84 and second side wall 86 while rear wall 82 is also orthogonal to first side wall 84 and second side wall 86.

FIG. 3 depicts the rear side of the weld curtain 10 having the screen 12, the top crossbar 14, bottom crossbar 16, first post 18, second post 20 and dowel 22. FIG. 3 further shows the components that secure bolts 46, 48, 60 and 62 with the top crossbar 14, bottom crossbar 16, first post 18, second post 20 and dowel 22. As provided herein, first bolt 46 secures top crossbar 14 and the first post 18 with one another and is threadably engaged with a first nut 90 to be retained with the top crossbar 14 and the first post 18. Similarly, second bolt 48 secures top crossbar 14 and second post 20 with one another and is threadably engaged with a second nut 92 to be retained with top crossbar 14 and second post 20, third bolt 60 secures the bottom crossbar 16 and first post 18 with one another and is threadably engaged to a third nut 94 to be retained with top crossbar 14 and second post 20, and a fourth bolt 62 secures the bottom crossbar 16 and second post 20 with one another and is threadably engaged with a fourth nut 96 to be retained with bottom crossbar 16 and the second post 20.

As previously stated, FIG. 4A and FIG. 4B depict the connection of top crossbar 14 and first post 18 in greater detail.

FIG. 4A depicts the top crossbar 14 as being housed inside of top sleeve 30 of screen 12 and being secured to first post 18 with first bolt 46 which is threadably engaged with first nut 90. First post 18 is also shown as being housed inside of first side sleeve 32 of screen 12.

FIG. 4B depicts each individual part of the securement mechanism, namely the bolt 46 and nut 90, used to secure top crossbar 14 to first post 18. As seen in FIG. 4B, first end 36 of top crossbar 14 has a first aperture 98 that is defined by the thickness of front wall 40. First end 36 of top crossbar 14 has a second aperture 100 that is defined by the thickness of rear wall 42. Top crossbar 14 has an open space or channel 102 defined by the height of front wall 40 and rear wall 42. Channel 102 also has a width as defined by the length of the top wall 44 of top cross bar.

First end 64 of first post 18 also has a first aperture 104 that is defined by the thickness of front wall 68. First end 64 of first post 18 has a second aperture 106 that is defined by the thickness of the rear wall 70. First post 18 has a perimeter formed by front wall 68, rear wall 70, first side wall 72 and second side wall 74 where the perimeter of the first post is generally smaller than the open space 102 of the top crossbar 14. First post 18 has an opening 108 that is defined by the front wall 68, rear wall 70, first side wall 72 and second side wall 74 where the cross-sectional shape of the first post 18 is generally square.

Top sleeve 30 has an opening 130 where the opening 130 is marginally larger than top crossbar 14. First side sleeve 32 has an opening 132 where the opening 132 is marginally larger than first post 18.

As previously stated, FIG. 5A and FIG. 5B depict the engagement between top crossbar 14 and second post 20; such engagement is now discussed in greater detail below.

FIG. 5A depicts the top crossbar 14 as being substantially housed inside of top sleeve 30 of screen 12 and shows top crossbar 14 being secured to second post 20 with second bolt 48 which is threadably engaged with second nut 92. Second post 20 is also substantially housed inside of sleeve 34 of screen 12.

FIG. 5B depicts each individual part of the securement mechanism used to secure top crossbar 14 to second post 20. Here, second end of top crossbar 14 has a third aperture 144 that is defined by the thickness of front wall 40. Second end 38 of top crossbar 14 has a fourth aperture 146 that is defined by the thickness of rear wall 42. Top crossbar 14 has open space or channel 102 defined by the height of front wall 40 and rear wall 42 and open space 102 has a width as defined by the length of the top wall 44.

First end 76 of second post 20 has a first aperture 148 that is defined by the thickness of front wall 80. First end 76 of second post 20 has a second aperture 150 that is defined by the thickness of the rear wall 82. Second post 20 has a perimeter formed by front wall 80, rear wall 82, first side wall 84, and second side wall 86 where the perimeter of the first post is generally smaller than the open space 102 of the top crossbar 14. Second post 20 has an opening 152 that is defined by the front wall 80, rear wall 82, first side wall 84, and second side wall 86, wherein the cross-sectional shape of the second post 20 is generally square.

As previously stated, FIG. 6A and FIG. 6B depict the engagement between bottom crossbar 16 and first post 18; such engagement is now discussed in greater detail below.

FIG. 6A depicts the bottom crossbar 16 as sitting below screen 12 creating a space 176 between bottom crossbar 16 and screen 12. FIG. 6A also shows bottom crossbar 16 being secured to first post 18 with third bolt 60, which is threadably engaged with third nut 94. First post 18 is inserted through sleeve 32 of screen 12. FIG. 6B depicts each individual part of the securement mechanism used to secure bottom crossbar 16 to first post 18.

As seen in FIG. 6B first end 50 of bottom crossbar 16 has a first aperture 178 that is defined by the thickness of front wall 54. First end 50 of bottom crossbar 16 has a second aperture 180 that is defined by the thickness of rear wall 56. Bottom crossbar 16 has an open space or channel 182 defined by the height of front wall 54 and rear wall 56 and open space 182 has a width as defined by the length of the bottom wall 58. Second end 66 of first post 18 has a third aperture 184 that is defined by the thickness of front wall 68. Second end 66 of first post 18 has a fourth aperture 186 that is defined by the thickness of the rear wall 70. First post 18 has a perimeter formed by front wall 68, rear wall 70, first side wall 72, and second side wall 74 wherein the perimeter of the first post 18 is generally smaller than the open space 182 of the bottom crossbar 16.

As previously stated, FIG. 7A and FIG. 7B depict the engagement between bottom crossbar 16 and second post 20; such engagement is now discussed in in greater detail below.

FIG. 7A depicts the bottom crossbar 16 as sitting below screen 12 creating a space 176 between bottom crossbar 16 and screen 12. FIG. 7A shows bottom crossbar 16 being secured to second post 20 with fourth bolt 62 which is threadably engaged with fourth nut 96. Second post 20 is also substantially housed inside of second side sleeve 34 of screen 12.

FIG. 7B depicts each individual part of the securement mechanism, namely bolt 62 and nut 96, used to secure bottom crossbar 16 to second post 20. FIG. 7B also depicts how dowel 22 connects to bottom crossbar 16. Here, second end 52 of bottom crossbar 16 has a third aperture 198 that is defined by the thickness of front wall 54. Second end 52 of bottom crossbar 16 has a fourth aperture 200 that is defined by the thickness of rear wall 56. Bottom crossbar 16 has open space or channel 182 defined by the height of front wall 54 and rear wall 56 and open space 182 has a width as defined by the length of the bottom wall 58.

Second end 78 of second post 20 has a third aperture 202 that is defined by the thickness of front wall 80. Second end 78 of second post 20 has a fourth aperture 204 that is defined by the thickness of the rear wall 82. Second post 20 has a perimeter formed by front wall 80, rear wall 82, first side wall 84, and second side wall 86 wherein the perimeter of the first post is generally smaller than the open space 102 of the bottom crossbar 16. Bottom crossbar 16 has a fifth aperture 216 that is defined by the thickness of the bottom wall 58 of bottom crossbar 16. A fifth bolt 218 is shown which may be received by aperture 216 in the bottom crossbar 16. Dowel 22 is a generally cylindrical body with a threaded aperture 224. The threaded aperture 224 may receive bolt 218 to secure the dowel 22 to the bottom crossbar 16. Dowel 22 may further include a cylindrical wall 226 that is formed between a top end 228 and a bottom end 230 of the dowel 22; such cylindrical wall allows the dowel 22 to swivel or rotate inside of an opening defined by a support structure or weld table.

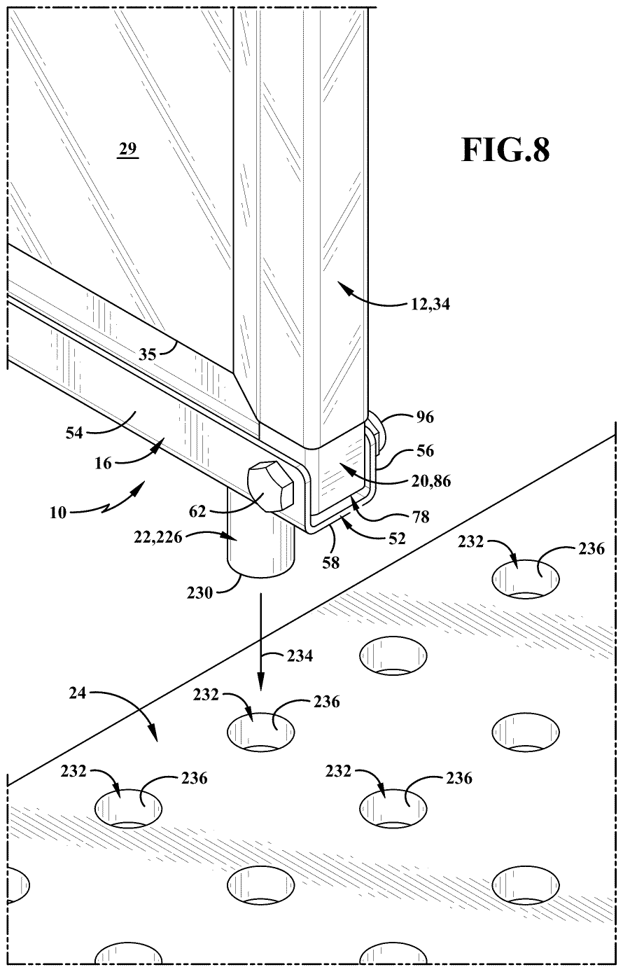

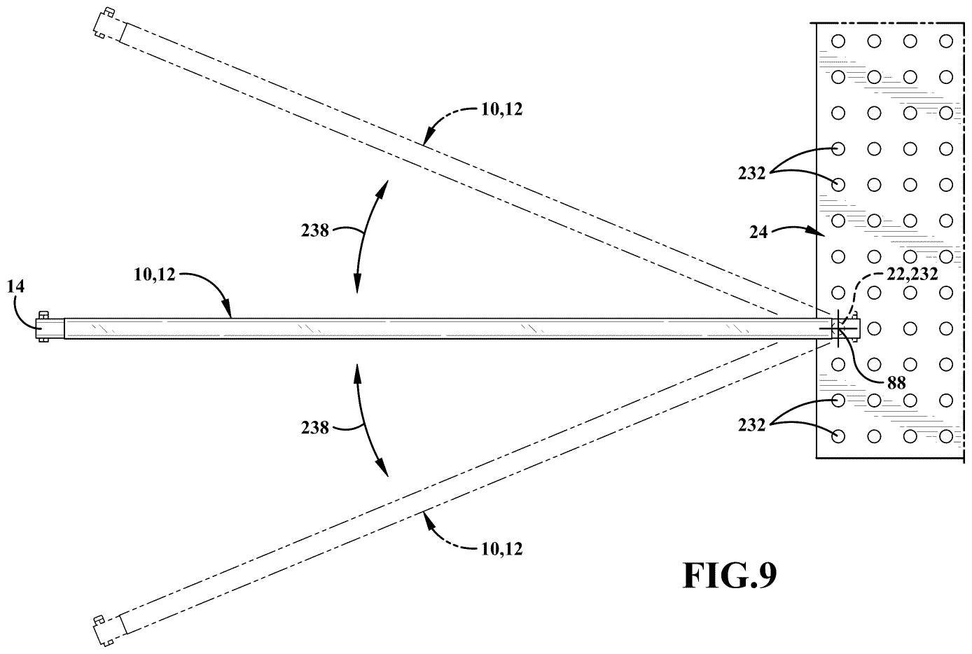

FIGS. 8-9 depict the method or procedure of securing the weld curtain with a weld table or similar support structure. In FIG. 8 the dowel 22 is configured to be inserted into an opening 232 on a weld table 24 as shown by arrow 234. The opening 232 has a marginally larger circumference than the diameter of dowel 22 so that opening 232 may receive dowel 22. The exterior surface 226 of dowel 22 may come into contact with side wall 236 of opening 232 on the weld table 24 to ensure that the dowel 22 fits securely in the opening 232 to provide for an upright position upon being inserted into the opening 232. Further, FIG. 9 depicts the rotation of weld curtain 10 about the weld table 24. Movement arrows 238 depict the weld curtain 10 moving about axis 88 while the dowel 22 is inserted into the opening 323 of the weld table 24. The dowel 22 fits snugly into the opening 232 to allow for rotation about the axis 88. The bottom crossbar 16 of weld curtain 10 may sit a marginal distance above the weld table 24 to allow for smooth rotation of the weld curtain 10 about the axis 88. The dowel 22 may be different lengths depending on the thickness of the weld table 24 and the length of the side wall 236 to ensure a secure fit.

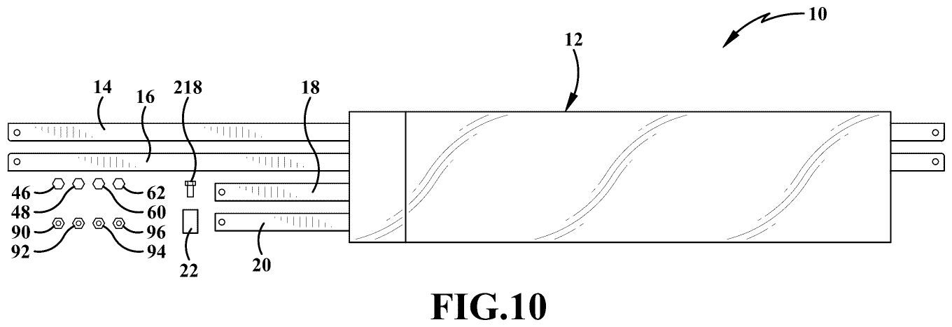

FIG. 10 depicts the first embodiment of the weld curtain 10 as disassembled. In this disassembled configuration, the first crossbar 14 may remain inside of the top sleeve 30, and the screen 12 may be slid along the crossbar 14 to be folded to have a smaller shape. Bolts 46, 48, 60, and 62 may be removed from the four corners of the frame as well as removing the bolt 218 from the dowel 22 so that the dowel may be removed from the bottom crossbar 16. Once all bolts are removed, the bottom crossbar 16, first post 18, and second post 20 may then be disconnected from one another and laid flat for easy storage, shipping, or any other need for dissembling the weld curtain 10.

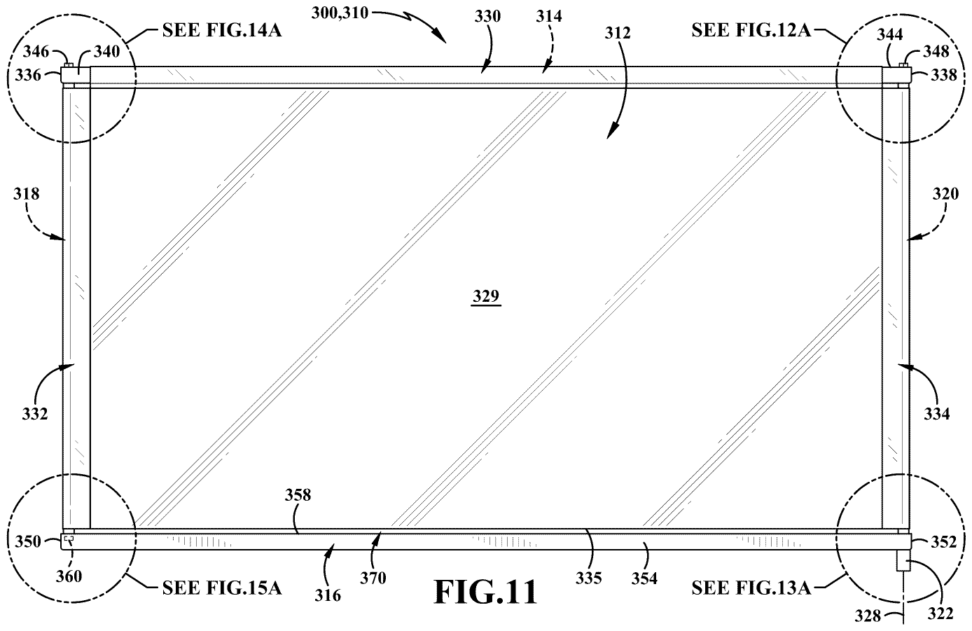

FIG. 11 depicts a second embodiment of weld curtain 10, shown generally as 300 and having similar parts with similar numbers herein. Second embodiment of weld curtain 310 includes a screen 312, top crossbar 314, bottom crossbar 316, first rod 318, second rod 320, dowel 322. The second embodiment may work in conjunction with a weld table 24, cobot 26, and welded material 28 that is not shown in FIG. 11-FIG. 13B. The top crossbar 314, the bottom crossbar 316, the first rod 318, and the second rod 320 collectively define, when assembled together, a frame that carries or otherwise supports the screen 312 to form the weld curtain 310.

FIG. 11 depicts the screen 312 that is generally rectangular in shape. Screen 312 may have a viewing portion 29 of the screen 12. Screen 12 may include a top sleeve 330, a first side sleeve 332, and a second side sleeve 334. In one exemplary embodiment, the screen 312 may be a green semitransparent weld curtain. The top sleeve 330 is adjacent to both the first side sleeve 332 and the second side sleeve 334, where the first side sleeve 332 and the second side sleeve 334 are parallel to one another and on opposite sides of the screen 312. Top sleeve 330 is generally longer than both first side sleeve 332 and second side sleeve 334, but first side sleeve 332 and second side sleeve 334 are substantially equal in length. In another exemplary embodiment, there may be a bottom sleeve which would be opposite of top sleeve 330. Top sleeve 330, first side sleeve 332, and second side sleeve 334 are located around a perimeter of the screen 312, which is a generally rectangular shape. Screen 312 may also have a bottom edge 335 that may extend from first side sleeve 332 to second side sleeve 334. Top sleeve 330 extends fully along the length of the screen 312, while first side screen 332 and second side screen 334 extend fully along the height of the screen 312. In another exemplary embodiment, screen 312 may include a plurality of loops extending from each edge of the screen 312 rather than having a solid, single sleeve at each edge of the screen as previously described.

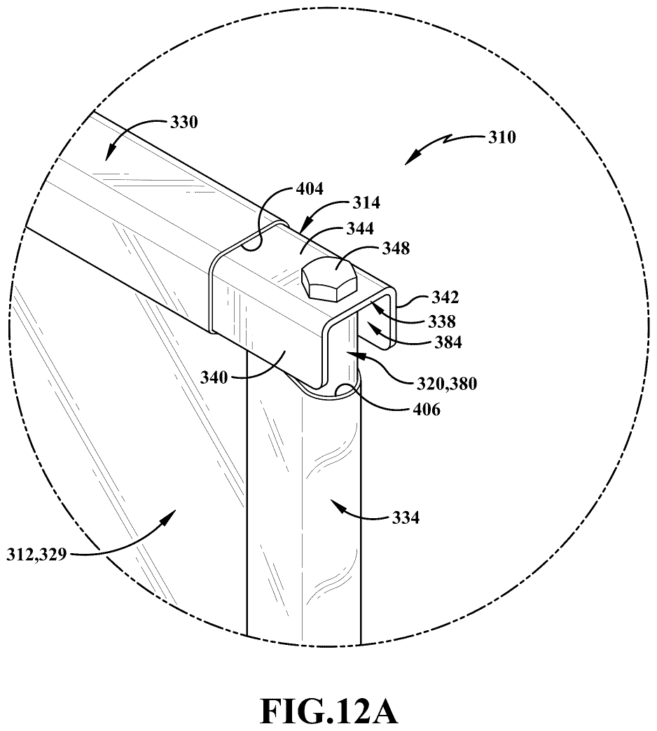

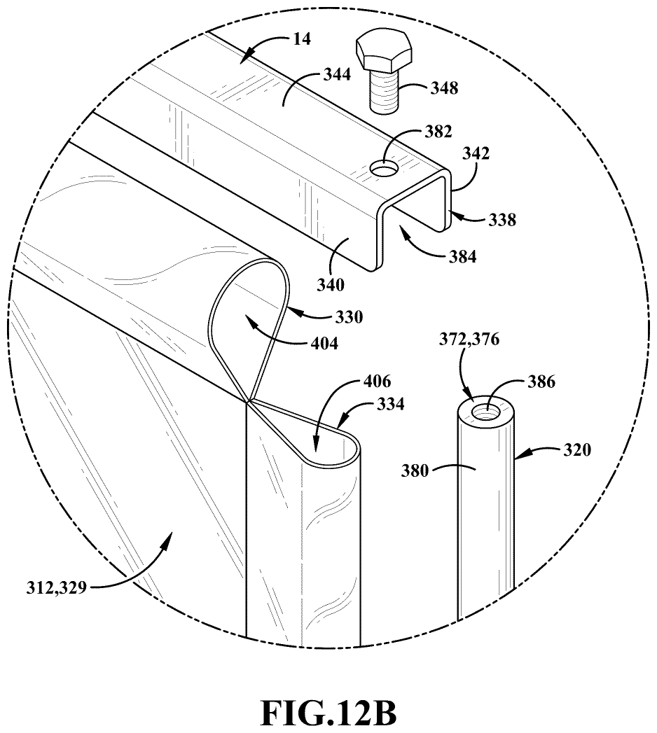

FIG. 11 depicts the top crossbar 314 having a first end 336, a second end 338 opposite to the first end 336, and a lengthwise axis extending between the first end 336 and the second end 338. Top crossbar 314 may have front wall 340 and a rear wall 342 that are connected by a top wall 344 collectively defines a generally downward facing U-shaped cross-section creating a downward facing U-shaped channel therein. The purpose of top crossbar 314 having walls that define a channel may be to save weight for easier use and movement for the end user, and to save weight in shipping costs. First end 336 of the top crossbar 314 may also be configured to receive and engage with a first bolt 346. Second end 338 of the top crossbar 314 may also be configured to receive and engage with a second bolt 348 which will be described in more detail in FIG. 12A and FIG. 12B.

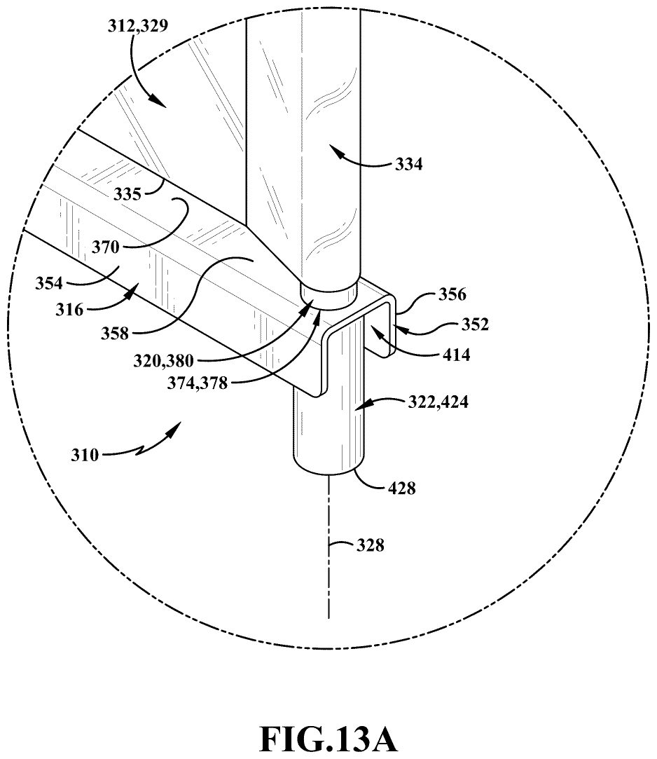

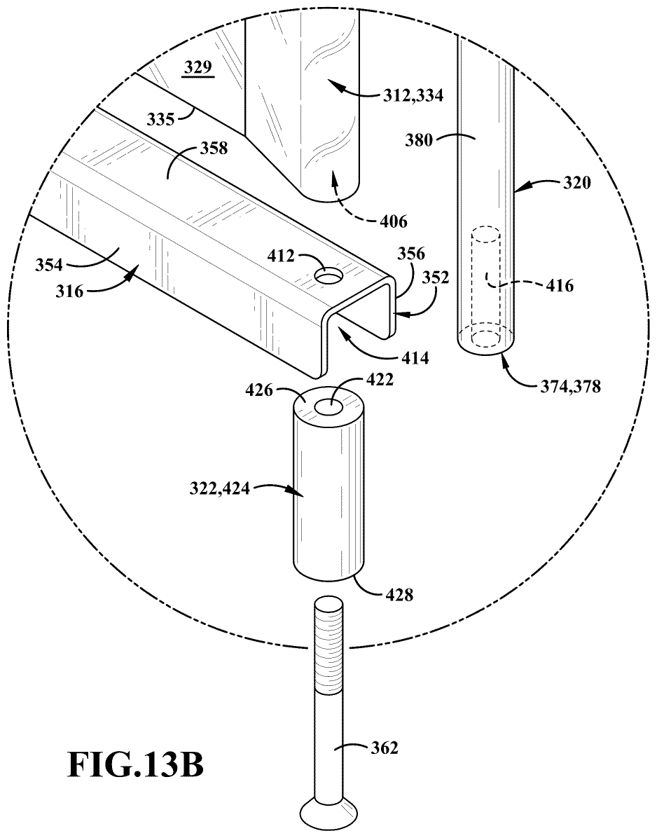

FIG. 11 depicts the bottom crossbar 316 having a first end 350 a second end 352 opposite to the first end 352, and a lengthwise axis extending between the first end 350 and the second end 352. Bottom crossbar 316 may have a front wall 354 and a rear wall 356 where the front wall 354 and the rear wall 356 are connected by a top wall 358. The bottom crossbar 316 is a generally downwardly facing U-shaped crossbar, creating a generally downwardly facing U-shaped channel therein. The purpose of bottom crossbar 316 having walls that define a channel may be to save weight for easier use and movement for the end user, and to save weight in shipping costs. Second end 352 of the bottom crossbar 316 may also be configured to receive and engage with a fourth bolt 362, which will be described in more detail in FIG. 13A and FIG. 13B. Further, the dowel 322 engages with the second end 352 of the bottom crossbar 316 and has an axis 328 extending longitudinally through the dowel 322, which will be discussed in further detail herein.

Top sleeve 330 of screen 312 is configured to receive the top crossbar 314. Top sleeve 330 extends the majority of the length of the top crossbar 314 but top crossbar 314 may have a greater length than the top sleeve 330 of screen 312. Top crossbar 314 and bottom crossbar 316 are substantially equal in length and width. Top crossbar 314 and bottom crossbar 316 are also parallel to one another while bottom crossbar 316 sits just below the bottom of screen 312.

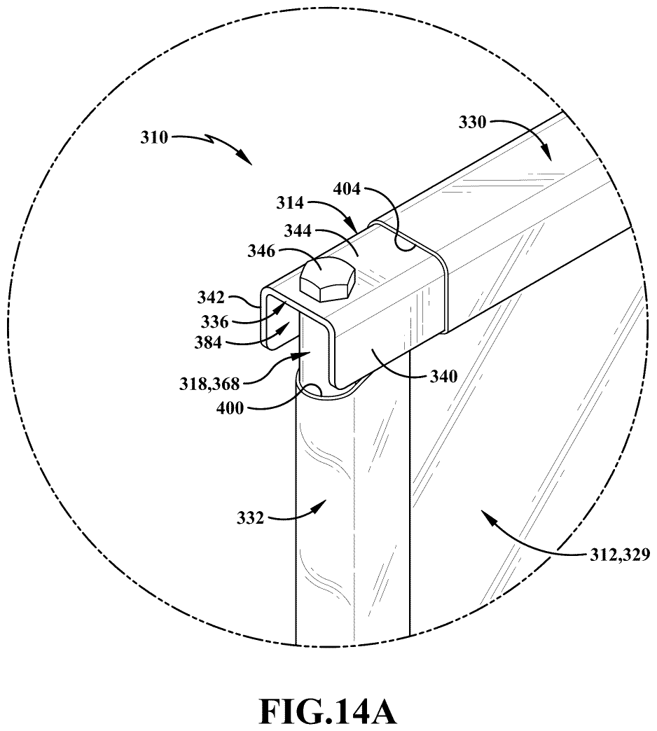

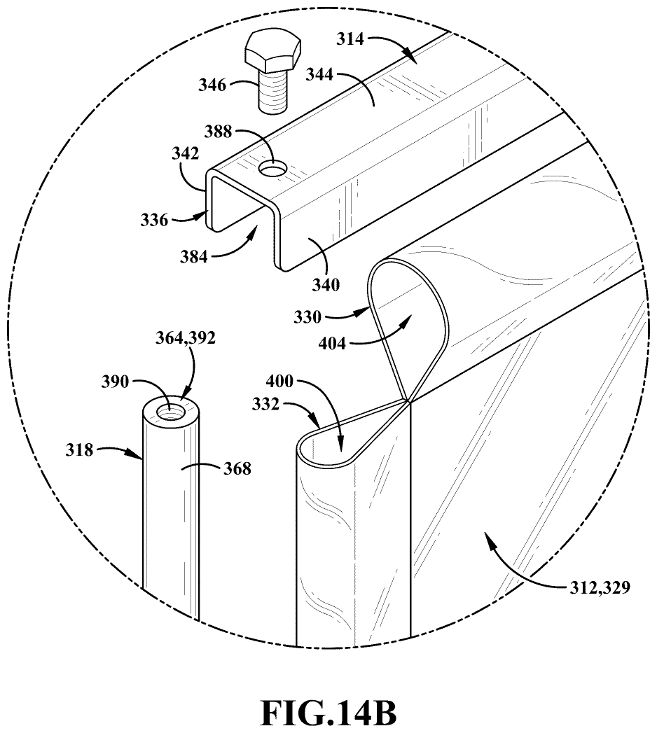

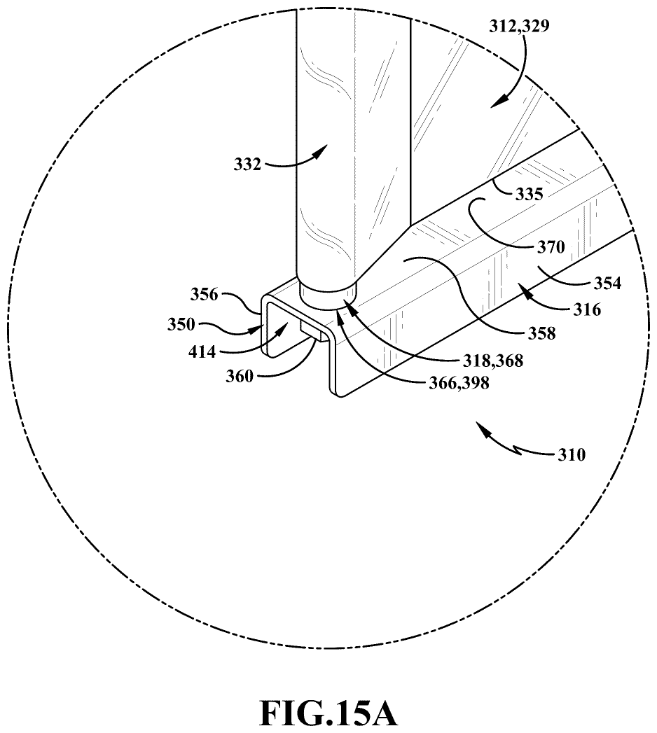

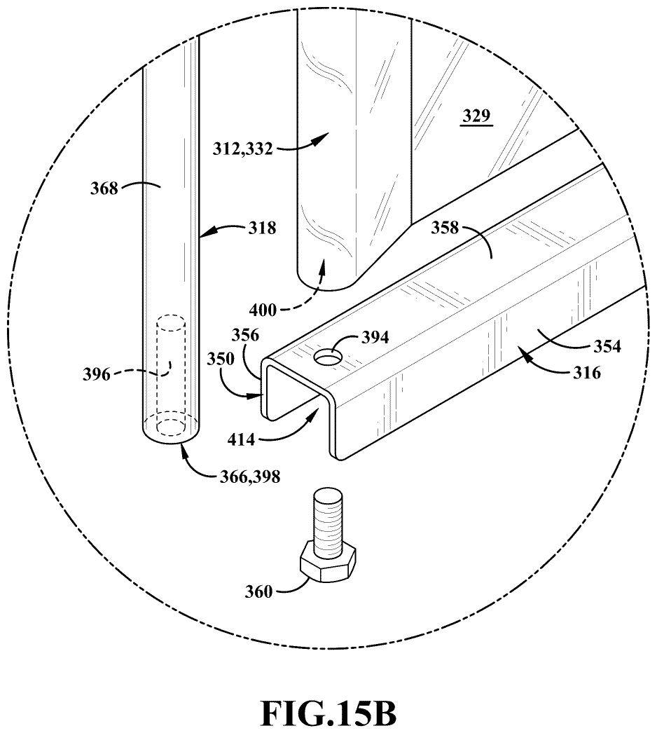

First rod 318 has a first end 364, a second end 366 opposite to the first end 364, and a longitudinal axis extending between the first end 364 and the second end 366. First rod 318 has a cylindrical wall 368 that extends between the first and second ends 364, 366 to create an elongated cylindrical shape, and will be discussed further in FIG. 14 and FIG. 15 herein. Second rod 320 has a first end 376, a second end 378 that is opposite to is the first end 376, and a longitudinal axis extending between the first end 376 and the second end 378. Second rod 320 has a cylindrical wall 380 that extends between the first and second ends 364, 466 to create an elongated cylindrical shape.

As previously stated, FIG. 12A and FIG. 12B depict the engagement between top crossbar 314 and second rod 320 in greater detail. FIG. 12A depicts the top crossbar 314 housed inside of top sleeve 330 of screen 312 and shows top crossbar 314 being secured with second rod 320 by first bolt 348. Second rod 320 is housed inside of the first side sleeve 334 of screen 312. It is to be understood that during assembly, the first rod 318 is inserted through the first side sleeve 332 of screen 312 in the same manner as second rod 320 being inserted through the second side sleeve 334 of screen.

As seen in FIG. 12B, second end 338 of top crossbar 314 has an aperture 382 that is defined by the thickness of top wall 344. Top crossbar 314 has open space or channel 384 defined by the height of front wall 340 and rear wall 342 and open space 384 has a width as defined by the length of the top wall 344.

A first end 376 of second rod 320 has a first threaded aperture 386 that is defined by the thickness of curved side wall 380. The threaded aperture 386 may extend from the top surface 372 to the bottom surface 374 of second rod 320 or may extend only partially through the body of second rod 320. In this exemplary embodiment, the threaded aperture 386 only extends partially through the second rod 320. Second rod 320 has a diameter formed by the cylindrical wall 320, which is generally smaller than the open space 384 of the top crossbar 314.

Top sleeve 330 has an opening where the opening 404 is marginally larger than top crossbar 314. First side sleeve 332 has an opening 400, where the opening 400 is marginally larger than first rod 318. Second side sleeve 334 has an opening 406, where the opening 404 is marginally larger than second rod 320.

As previously stated, FIG. 13A and FIG. 13B depict the engagement between bottom crossbar 316 and second rod 320 in greater detail.

FIG. 13A depicts the bottom crossbar 316 as sitting below screen 312 creating a space 370 between bottom crossbar 316 and screen 312. FIG. 13A shows bottom crossbar 316 being secured with second rod 320 with fourth bolt 362 which is longer than bolt 346, 348, and 360 which are all of substantially similar lengths and may be used at all other points of connection for the frame of the weld curtain 10. Second rod 320 is inserted through and housed inside of second side sleeve 334 of screen 312.

FIG. 13B depicts each individual part of the securement mechanism used to secure bottom crossbar 316 to second post 320. FIG. 13B also depicts how dowel 322 connects to bottom crossbar 316. Here, second end 352 of bottom crossbar 316 has an aperture 412 that is defined by the thickness of top wall 358. Bottom crossbar 316 has open space or channel 414 defined by the height of front wall 354 and rear wall 356, and open space 414 has a width as defined by the length of the top wall 358.

Second end 378 of second rod 320 has an aperture 416 that is defined by the thickness of cylindrical wall 380. The threaded aperture 416 may extend only partially through the body of second rod 320 from the bottom surface 374 of the rod 320. Second rod 320 has a diameter formed by the cylindrical wall 320, which is generally smaller than the open space 384 of the bottom crossbar 316. Dowel 322 also includes a cylindrical wall 424 that is formed between a top end 426 of dowel 322 and a bottom end 428 of dowel 322.

As previously stated, FIG. 14A and FIG. 14B depict the engagement between top crossbar 314 and first rod 318 in greater detail. FIG. 14 depicts the top crossbar 314 housed inside of top sleeve 330 of screen 312 and shows top crossbar 314 being secured with first rod 318 by first bolt 346. First rod 318 is housed inside of the first side sleeve 332 of screen 312. As seen in FIG. 14B, first end 336 of top crossbar 314 has an aperture 388 that is defined by the thickness of top wall 344. Top crossbar 314 has open space or channel 384 defined by the height of front wall 340 and rear wall 342 and open space 384 has a width as defined by the length of the top wall 344.

A first end 364 of first rod 318 has a first threaded aperture 390 that is defined by the thickness of curved side wall 368. The threaded aperture 390 may extend from the top surface 392 to the bottom surface 394 of first rod 318 or may extend only partially through the body of the first rod 318. In this exemplary embodiment, the threaded aperture 390 only extends partially through the first rod 318. First rod 318 has a diameter formed by the cylindrical wall 368, which is generally smaller than the open space 384 of the top crossbar 314.

As previously stated, FIG. 15A and FIG. 15B depict the engagement between bottom crossbar 316 and first rod 318 in greater detail.

FIG. 15A depicts the bottom crossbar 316 as sitting below screen 312 creating a space 370 between bottom crossbar 316 and screen 312. FIG. 15A shows bottom crossbar 316 being secured with first rod 318 with third bolt 360. First rod 318 is inserted through and housed inside of first side sleeve 332 of screen 312. FIG. 15B depicts each individual part of the securement mechanism used to secure bottom crossbar 316 to first rod 318. Here, first end 350 of bottom crossbar 316 has an aperture 394 that is defined by the thickness of top wall 358. Bottom crossbar 316 has open space or channel 414 defined by the height of front wall 354 and rear wall 356, and open space 414 has a width as defined by the length of the top wall 358.

Second end 366 of first rod 318 has an aperture 396 that is defined by the thickness of cylindrical wall 368. The threaded aperture 396 may extend only partially through the body of first rod 318 from the bottom surface 398 of the rod 318. First rod 318 has a diameter formed by the cylindrical wall 368, which is generally smaller than the open space 384 of the bottom crossbar 316. First side sleeve 332 has an opening 400 where opening 400 is marginally larger than first rod 318.

In operation, the dowel 322 would be inserted into an opening defined in a weld table similar to how dowel 22 of weld curtain 10 is inserted into an opening defined by a weld table as described in the first exemplary embodiment. The opening on the weld table has a marginally larger circumference than the diameter of dowel 322 so that opening may receive dowel 322. Similar to dowel 22 of weld curtain 10, the cylindrical wall 424 of dowel 322 may come into contact with side wall of the opening on the weld table to ensure that the dowel 322 fits securely in the opening to provide for an upright position upon being inserted into the opening. The weld curtain 310 may move about a rotational axis defined by dowel 322 (similar to axis 88 described above) while the dowel 322 is inserted into the opening of the weld table. The dowel 322 fits snugly into the opening to allow for rotation of the weld curtain 310 about the axis. The bottom crossbar 316 of weld curtain 310 may sit a marginal distance above the weld table to allow for smooth rotation of the weld curtain 310 about the axis of dowel 322. The dowel 322 may be different lengths depending on the thickness of the weld table and the length of the side wall to ensure a secure fit.

Although not discussed in detail in the second embodiment of the weld curtain 310, it is to be understood that the top cross bar 314 and the bottom cross bar 316 are identical to one another. Further, it should be understood that first rod 318 and second rod 320 are substantially similar in that the first end 376 of the second rod is the same as the first end 364 of the first rod 318 and the second end 366 of the first rod 318. However, the second end 378 of the second rod 320 is different in that the threaded aperture is longer, but all threaded apertures on the first rod 318 and the second rod 320 may be of the same length.

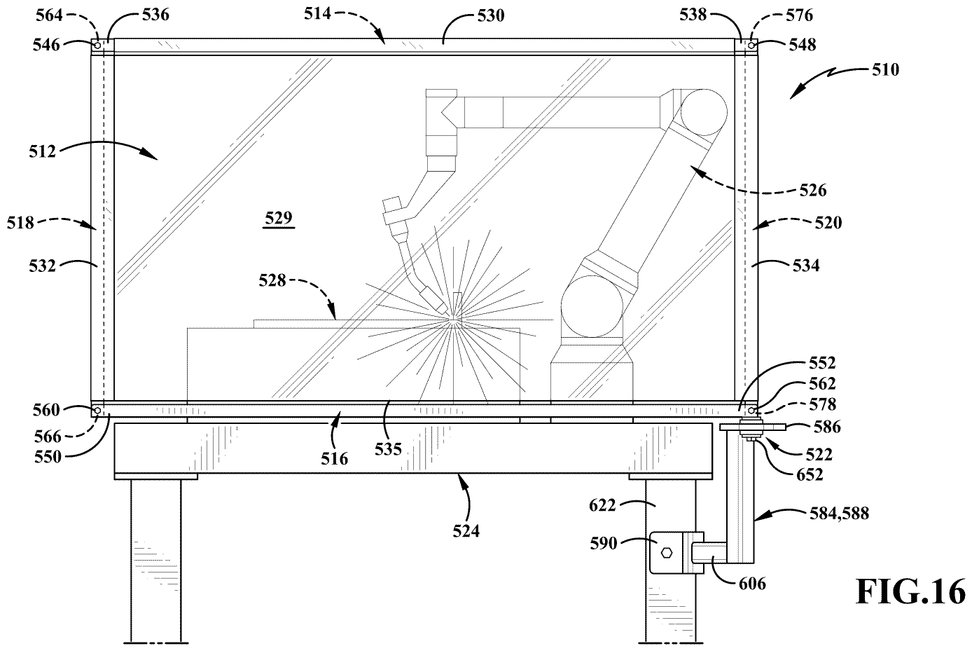

FIG. 16 depicts a third embodiment of the weld curtain shown generally as 510. It is to be understood that the third embodiment is substantially similar to the embodiments listed above. Particularly, the weld curtain 510 includes a screen 512, a top crossbar 514, a bottom crossbar 516, a first rod 518, a second rod 520, and a connection point 522, which will be discussed in greater detail herein. The weld curtain 510 works in conjunction with a weld table 524, a cobot 526, and welded material 528. The screen 512 includes a viewing portion 529. The top crossbar 514, the bottom crossbar 516, the first rod 518, and the second rod 520 collectively define, when assembled together, a frame that carries or otherwise supports the screen 512 to form the weld curtain 510.

FIG. 16 depicts the screen 512 that is generally rectangular in shape. Screen 512 may include a top sleeve 530, a first side sleeve 532, and a second side sleeve 534. In one exemplary embodiment, the screen 512 may be a green semitransparent weld curtain. The top sleeve 530 is adjacent to both the first side sleeve 532 and the second side sleeve 534, where the first side sleeve 532 and the second side sleeve 534 are parallel to one another and on opposite sides of the screen 512. Top sleeve 530 is generally longer than both first side sleeve 532 and second side sleeve 534, but first side sleeve 532 and second side sleeve 534 are substantially equal in length. In another exemplary embodiment, there may be a bottom sleeve which would be opposite of top sleeve 530. Top sleeve 530, first side sleeve 532, and second side sleeve 534 are located around a perimeter of the screen 512, which is a generally rectangular shape. Screen 512 may also have a bottom edge 535 that may extend from first side sleeve 532 to second side sleeve 534. Top sleeve 530 extends fully along the length of the screen 512, while first side sleeve 532 and second side sleeve 534 extend fully along the height of the screen 512. In another exemplary embodiment, screen 512 may include a plurality of loops extending from each edge of the screen 512 rather than having a solid, single sleeve at each edge of the screen as previously described. It is to be understood that the top sleeve 530, first side sleeve 532 and second side sleeve 534 each have an opening to receive the top crossbar 514, first rod 518 and second rod 520, respectively.

FIG. 16 also depicts the top crossbar 514 having a first end 536, a second end 538 opposite to the first end 536, and a lengthwise axis extending between the first end 536 and the second end 538. It is to be understood that top crossbar 514 may have front wall and a rear wall that are connected by a top wall collectively defines a generally downward facing U-shaped cross-section creating a downward facing U-shaped channel therein. The purpose of top crossbar 514 having walls that define a channel may be to save weight for easier use and movement for the end user, and to save weight in shipping costs. First end 536 of the top crossbar 514 may also be configured to receive and engage with a first bolt 546. Second end 538 of the top crossbar 514 may also be configured to receive and engage with a second bolt 548.

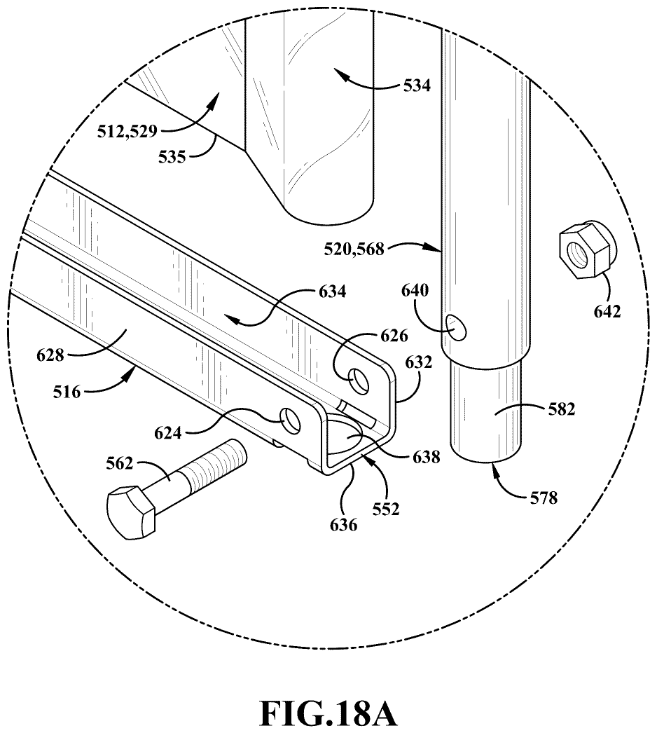

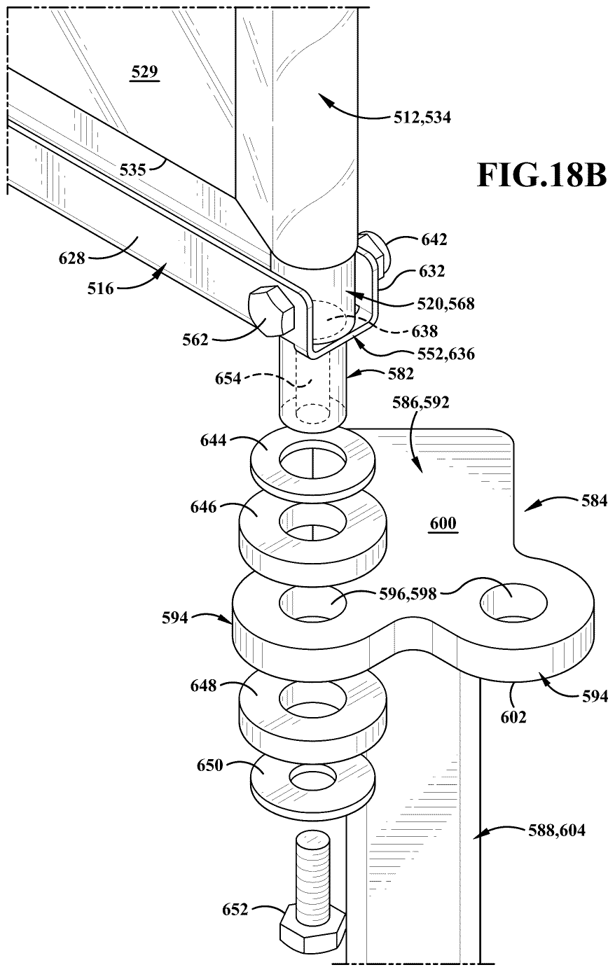

FIG. 16 depicts the bottom crossbar 516 having a first end 550 a second end 552 opposite to the first end 552, and a lengthwise axis extending between the first end 550 and the second end 552. It is to be understood that bottom crossbar 516 may have a front wall and a rear wall where the front wall and the rear wall are connected by a top wall. The bottom crossbar 516 is a generally upwardly facing U-shaped crossbar, creating a generally upwardly facing U-shaped channel therein. The purpose of bottom crossbar 516 having walls that define a channel may be to save weight for easier use and movement for the end user, and to save weight in shipping costs. First end 550 of the bottom cross bar 516 may also be configured to receive and engage with a third bolt 560. Second end 552 of the bottom crossbar 516 may also be configured to receive and engage with a fourth bolt 562, which will be described in more detail in FIG. 18A and FIG. 18B. Further, the connection point 522 engages with the second end 552 of the bottom crossbar 516 and has an axis extending longitudinally through the connection point 522, which will be discussed in further detail herein.

Top sleeve 530 of screen 512 is configured to receive the top crossbar 514. Top sleeve 530 extends the majority of the length of the top crossbar 514 but top crossbar 514 may have a greater length than the top sleeve 530 of screen 512. Top crossbar 514 and bottom crossbar 516 are substantially equal in length and width. Top crossbar 514 and bottom crossbar 516 are also parallel to one another while bottom crossbar 516 sits just below the bottom of screen 512.

First rod 518 has a first end 564, a second end 566 opposite to the first end 564, and a longitudinal axis extending between the first end 564 and the second end 566. First rod 518 has a cylindrical wall 568, shown in FIG. 18A, that extends between the first and second ends 564, 566 to create an elongated cylindrical shape, and will be discussed further in FIG. 18A herein. Second rod 520 has a first end 576, a second end 578 that is opposite to is the first end 576, and a longitudinal axis extending between the first end 576 and the second end 578. Second rod 520 has a cylindrical wall 580 that extends between the first and second ends 564, 566 to create an elongated cylindrical shape. The second rod 520 also has an extension 582 (otherwise referred to as a dowel herein) that has a smaller circumference than that of the rest of the rod 520 and will be described in further detailed herein.

It is to be understood that there is an aperture at each end of both the first rod 518 and the second rod 520 as well as an aperture at each end of both the top channel 514 and bottom channel 516 to receive the bolts 546, 548, 560, and 562. A first aperture (not shown) may be located at the first end 564 of the first rod 518 an additional aperture (not shown) may be located at the first end 536 of the top channel 514. The aperture on the first end of the top channel 514 and the aperture on the first end of the first rod 518 may be aligned to receive bolt 546 which may extend through the top channel 514 and the first rod 518 to create a connection point. A second aperture (not shown) may be located on the second end 538 of the top channel 514 and an additional aperture (not shown) may be located on the first end 576 of the second rod 520. The aperture on the first end 538 of the top channel 514 and the aperture on the first end 576 of the second rod 520 may be aligned to receive bolt 548. A third aperture (not shown) may be located at the second end 566 of the first rod 518 and an additional aperture (not shown) may be located on the first end 550 of the bottom channel 516. The aperture on the first end 550 of the bottom channel 516 and the aperture on the second end 566 of the first rod may be aligned to receive bolt 560. A fourth aperture (not shown) may be located at the second end 552 of the bottom channel 516 and an additional aperture (not shown) may be located at the second end 578 of the second rod 520. The aperture on the second end 552 of the bottom channel 516 and the aperture located at the second end 578 of the second rod 520 may be aligned to receive bolt 562. The connection point with bolt 562 will be discussed in greater detail herein as this connection differs slightly from the remainder of the connection points.

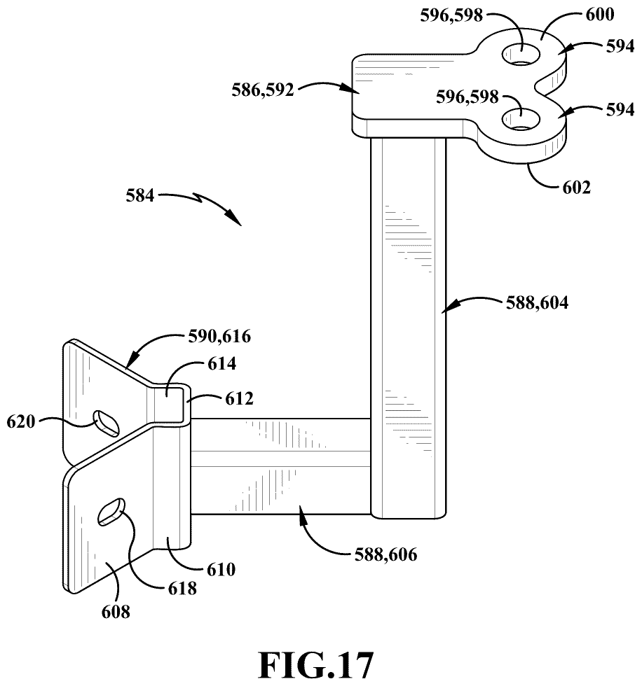

FIG. 17 depicts a connector 584. The connector 584 has a top bracket 586, a main body 588, and a corner bracket 590. The top bracket 586 has a rectangular body 592 with at least one lug 594 extending outwardly from the rectangular body 592. The at least one lug 594 may have an aperture 596 that is defined by the sidewall 598 and extends from a top surface 600 to a bottom surface 602 of the top bracket 586. In one exemplary embodiment there may be two bifurcating lugs 594 on the top bracket 586.

Still referring to FIG. 17, the main body 588 includes a first member 604. The first member 604 extends downwardly from the bottom surface 602 of the top bracket 586. The first member 604 is generally rectangular in shape and the longitudinal axis extending therein is parallel to the longitudinal axis extending through the apertures 596 on the top bracket 586. The main body 588 also includes a second member 606. The second member 606 extends outwardly from the first member 604 to form a generally L-shaped main body 588. The second member 606 further connects to the corner bracket 590 in which the corner bracket 590 is spaced apart from the top bracket 586 and is positioned vertically below the top bracket 586 relative to the main body 588.

Still referring to FIG. 17, the corner bracket 590 includes a first wall 608, wherein the first wall is at an angle relative to a second wall 610. The second wall 610 is connected to a rear wall 612. The rear wall 612 is connected to a third wall 614, wherein the second wall 610, rear wall 612 and third wall 614 create a generally U-shaped portion of the corner bracket 590. The third wall 614 is attached to the fourth wall 616 wherein the fourth wall 616 is at an angle relative to the third wall 614. The first wall 608 and the fourth wall 616 are spaced a further distance apart than the second wall 610 and the third wall 614. The first wall 608 and the fourth wall 616 form a general V-shaped section of the corner bracket 590. The first wall 608 includes a bore 618 that is defined by the thickness of the first wall 608, and the fourth wall 616 includes an identical bore 620 that is defined by the thickness of the fourth wall 616. The bores 618 and 620 are generally oval in shape and are configured to receive a bolt to secure the corner bracket 590 to a leg 622 of the weld table 524.

FIG. 18A further depicts the connection of the bottom channel 516 to the second rod 520. The second end 552 of the bottom channel 516 further defines a first aperture 624 and a second aperture 626. The first aperture 624 is defined by the thickness of a front wall 628 while the second aperture 626 is defined by the thickness of a rear wall 632. Bottom crossbar 516 has an open space or channel 634 defined by the height of the front wall 628 and rear wall 632 and defined by the width of a bottom wall 636. It is to be understood that the first end 550 of the bottom channel 516 may include the same features as mentioned above. It is also to be understood that the first end 536 of the top channel 514 and the second end 538 of the top channel 510 may have the same features as described above. The bottom channel 516 has a third aperture 638 that is defined by the thickness of the bottom wall 636. The second rod 520 may have a first aperture 640 and a second aperture (not shown) where each aperture is configured to receive the bolt 562; the second aperture defined on the second rod 520 is defined in the opposite side of the second rod 520. A nut 642 may be threaded to the bolt 562 once the bolt 562 passes through both apertures on the second rod 520.

It is to be understood that the first end 576 of the second rod 520 is substantially similar to the second end 578. The first end 576 may not include the extension 582, but all other features such as the first aperture 640 and the second aperture (not shown) will be present in the first end 576. The means of connecting the first end 576 of the second rod 520 to the top channel 514 is also substantially similar to that of the aforementioned connection. It should be understood that the first rod 518 is substantially similar to the second rod 520, but the first rod 518 may not include the extension 582 at either the first end 564 or the second end 566 of the first rod 518. The means of connecting the first end 564 of the first rod 518 to the first end 536 of the channel 514 is substantially similar to the mechanism used to connect the second end 578 of the second rod 520 except for the top channel 514 may not include a third aperture 638 as there may not be an extension 582 on the first rod 518. The means of connecting the second end 566 of the first rod 518 to the first end 550 of the bottom channel is substantially similar to the mechanism used to connect the second end 578 of the second rod 520 except for the first end 550 of the bottom channel 516 may not include a third aperture 638 as there may not be an extension 582 on the first rod 518.

It is also to be understood that the connection of the rods and the channels as described in the third embodiment may also be used in any of the previous embodiments. The methods for connecting the rods and channels as described in the previous embodiments may also be used in the third embodiment. All means of connecting the rods or posts to the channels may be used in any of the embodiments and any combination thereof is acceptable.

FIG. 18B further depicts the connection point 522. The connection point 522 includes the connector 584 and the extension 582 of the second rod 520. The extension 582 of the second rod 520 may be configured to engage with the aperture 596 of the at least one lug 594 of the top bracket 586. To secure the extension 582 of the second rod 520 with the connector 584, a first washer 644 receives the extension 582 and rest below the bottom channel 516 upon assembly. A second washer 646 receives the extension 582 of the second rod and contacts the first washer 644 and the top surface 600 of the top bracket 586 upon assembly. A third washer 648 contacts the bottom surface 602 of the top bracket 586. A fourth washer 650 contacts the third washer 648 and a bolt 652 upon assembly. The third washer 648 and the fourth washer 650 are configured to receive the bolt 652. The extension 582 includes a threaded aperture 654 that is configured to threadably engage with the bolt 652 to secure the connection point 522 between the extension 582 and the connector 584.

The washers 646,648 allow the weld curtain 510 to pivot/rotate on the connector 584, while the washers 644,650 spread the force along a greater surface area at the bottom crossbar 516 around the extension 582 at the head of the bolt 652.

This exemplary embodiment is advantageous because it does not sacrifice any space along the work surface of the weld table while still allowing for rotation to provide safety at various angles along a work station. This exemplary embodiment is also advantageous because it allows for quick adjustability of the weld curtain with the top bracket of the connector to account for various weld table sizes, shapes, and configurations.

In one exemplary embodiment, the side posts and/or rods mentioned herein, namely first post 18, second post 20, first rod 318, second rod 320, first rod 518, and second rod 520 may be within a range of about 12 in-32 in and may be considered to be upright supports or linear supports. The top crossbar and bottom crossbar, namely top crossbar 14, bottom crossbar 16, top crossbar 314, bottom crossbar 316, top crossbar 514, and bottom crossbar 516 may be within a range of about 26 in-46 in creating a generally rectangular shape for weld curtains mentioned herein. In another exemplary embodiment the first post 18, second post 20, first rod 318, second rod 320, first rod 518, and second rod 520 may be approximately 22.7 inches. In another exemplary embodiment top crossbar 14, bottom crossbar 16, top crossbar 314, bottom crossbar 316, top crossbar 514, and bottom crossbar 516 may be approximately 36.5 inches.

In another exemplary embodiment there may only be two posts 18 and 20 or two rods 318 and 320 or two rods 518 and 520 wherein the dowel or extension is located on the bottom of either post or rod, and the top sleeves 30, 330, 530 of the respective screen 12, 312, 512 are closed and rigid so that the dowel or extension may support the weld curtain. The posts or rods may be parallel to one another or form a generally L-shape to provide the screen enough structure while creating the frame from only two parallel supports. In another exemplary embodiment there may be only one of the posts or rods (18,20,318,320,518,520), or a crossbar (14,16,314,316,514,516) inserted into a sleeve of the weld curtain. The weld curtain may be rigid in this embodiment so that the dowel or extension may support the screen of weld curtain and the weld curtain may remain upright.

In another exemplary embodiment there may be an upright support (such as first post 18, second post 20, first rod 318, second rod 320, first rod 518, or second rod 520) and a crossbar (such as top crossbar 14, bottom crossbar 16, top crossbar 314, bottom crossbar 316, top crossbar 514, or bottom crossbar 516) where the two are substantially perpendicular to one another and meet to form an L-shape. In this exemplary embodiment, a top sleeve (such as top sleeve 30, 330, or 530) of a screen (such as screen 12, 312, or 512) would have closed end or sleeves opposite the ends or sides where the upright support and the crossbar would engage with one another. A dowel (such as dowel 22, 322, 582) would then engage with the upright support so that the weld curtain may be cantilevered from a weld table.

In another exemplary embodiment there may be two upright supports (such as first and second posts 18, 20 or first and second rods 318, 320, or first and second rods 518, 520) where the two upright supports are parallel to one another and are inserted into sleeves (sleeves 32, 34 or sleeves 332, 334 or sleeves 532,534) of a screen (such as screen 12, 312, 512). In this exemplary embodiment, screen may also have a closed top end or sleeve that is rigid such that the top end or sleeve of the screen is fully supported by itself. In this exemplary embodiment a dowel (such as dowel 22 or 322 or 582) may also engage with either one of the two upright supports so that the weld curtain may be cantilevered on the weld table.

In another exemplary embodiment, there may be a fourth sleeve wherein the fourth sleeve may receive the bottom crossbar 16 or bottom crossbar 316 or bottom crossbar 516.

The dowel 22, 322, or extension 582 may have interchangeable terms. The extension 582 may be called a dowel, a pivot rod, pivot post, pivot pin, or linear post to name a few. The dowel 22 and dowel 322 may have interchangeable terms as well. The dowel 22 and dowel 322 may be called an extension, a pivot rod, a pivot post, a pivot pin, or linear post to name a few.

Unless explicitly stated that a particular shape or configuration of a component is mandatory, any of the elements, components, or structures discussed herein may take the form of any shape. Thus, although the figures depict the various elements, components, or structures of the present disclosure according to one or more exemplary embodiments, it is to be understood that any other geometric configuration of that element, component, or structure is entirely possible. For example, instead of the weld curtain 10 being rectangular it may be square or any other shape listed below, or instead of the nuts being hexagonal they may be semi-circular triangular, rectangular or square, pentagonal, hexagonal, heptagonal, octagonal, decagonal, dodecagonal, diamond shaped or another parallelogram, trapezoidal, star-shaped, oval, ovoid, lines or lined, teardrop-shaped, cross-shaped, donut-shaped, heart-shaped, arrow-shaped, crescent-shaped, any letter shape (i.e., A-shaped, B-shaped, C-shaped, D-shaped, E-shaped, F-shaped, G-shaped, H-shaped, I-shaped, J-shaped, K-shaped, L-shaped, M-shaped, N-shaped, O-shaped, P-shaped, Q-shaped, R-shaped, S-shaped, T-shaped, U-shaped, V-shaped, W-shaped, X-shaped, Y-shaped, or Z-shaped), or any other type of regular or irregular, symmetrical or asymmetrical configuration.

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Any flowchart and/or block diagrams in the Figures illustrate some exemplary architecture, functionality, and operation of possible implementations of systems, methods, and computer program products according to various embodiments of the present disclosure. In this regard, each block in the flowchart or block diagrams may represent a module, segment, or portion of instructions, which includes one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc. As another example, “at least one of: A, B, or B” is intended to cover A, B, C, A-B, A-C, B-C, and A-B-C, as well as any combination with multiple of the same item.

While components of the present disclosure are described herein in relation to each other, it is possible for one of the components disclosed herein to include inventive subject matter, if claimed alone or used alone. In keeping with the above example, if the disclosed embodiments teach the features of A and B, then there may be inventive subject matter in the combination of A and B, A alone, or B alone, unless otherwise stated herein.

As used herein in the specification and in the claims, the term “effecting” or a phrase or claim element beginning with the term “effecting” should be understood to mean to cause something to happen or to bring something about. For example, effecting an event to occur may be caused by actions of a first party even though a second party actually performed the event or had the event occur to the second party. Stated otherwise, effecting refers to one party giving another party the tools, objects, or resources to cause an event to occur. Thus, in this example a claim element of “effecting an event to occur” would mean that a first party is giving a second party the tools or resources needed for the second party to perform the event, however the affirmative single action is the responsibility of the first party to provide the tools or resources to cause said event to occur.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present disclosure.

An embodiment is an implementation or example of the present disclosure. Reference in the specification to “an embodiment,” “one embodiment,” “some embodiments,” “one particular embodiment,” “an exemplary embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” “an exemplary embodiment,” or “other embodiments,” or the like, are not necessarily all referring to the same embodiments. Furthermore, the use of any and all examples or exemplary language (“e.g.,” “such as,” or the like) is intended merely to better illustrate or illuminate the embodiments and does not pose a limitation on the scope of that or those embodiments. No language in this specification should be construed as indicating any unclaimed element as essential to the practice of the disclosed embodiment.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element or “another” element, that does not preclude there being more than one of the additional element or the another element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein. Further, recitation of ranges of values herein are not intended to be limiting, referring instead individually to any and all values falling within that range, unless otherwise indicated herein, and each separate value within such range is incorporated into the specification as if it were individually recited herein.

Additionally, the method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

To the extent that the present disclosure has utilized the term “invention” in various titles or sections of this specification, or in the context of those sections, this term has been included as required by the formatting requirements of word document submissions (i.e., docx submissions) pursuant the guidelines/requirements of the United States Patent and Trademark Office and shall not, in any manner, be considered a disavowal of any subject matter.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

What is claimed is:

1. A weld curtain comprising:
a screen;
a frame having at least one support configured to support a portion of the screen; and
a linear post operably engaged with the frame and is adapted to rotatably engage the weld curtain to a weld table.

2. The weld curtain of claim 1, wherein the frame and the screen are fully supported by the linear post and wherein the frame and the screen are collectively cantilevered from the weld table by the linear post.

3. The weld curtain of claim 1, wherein the at least one support further comprises:
a first support that is configured to be received by a first sleeve of the screen;
a second support that is configured to be received by a second sleeve of the screen;
wherein the first support and the second support are perpendicular to one another; and wherein the first support and the second support operably engage with one another.

4. The weld curtain of claim 1, wherein the at least one support further comprises:
a first support that is configured to be received by a first sleeve of the screen;
a second support that is configured to be received by a second sleeve of the screen; and
wherein the first support and the second support are parallel to one another.

5. The weld curtain of claim 4, further comprising a third support, wherein the third support operably engages with the first support and the second support.

6. The weld curtain of claim 5 further comprising:
a first sleeve located at a first position on the screen and configured to receive the first support of the pair of supports;
a second sleeve located at a second position on the screen and configured to receive the second support; and
a third sleeve located at a third position on the screen that is configured to receive the third support of the frame.

7. The weld curtain of claim 5, wherein the third support comprises: a first end that is configured to receive and engage with a first portion of the first support; and a second end that is configured to receive and engage with a first portion of the second support.

8. The weld curtain of claim 7, further comprising: a first securement mechanism releasably engaging the first end of the third support and the first portion of the second support with one another and a second securement mechanism releasably engaging the second end of the third support and the first portion of the first support with one another.

9. The weld curtain of claim 8, further comprising a fourth support that operably engages with the first support and the second support.

10. The weld curtain of claim 9, wherein the fourth support comprises: a first end that is operably engaged with a second portion of the first support, and a second end that is operably engaged with a second portion of the second support, wherein the fourth support is parallel to the third support.

11. The weld curtain of claim 4, wherein the second support has a length within a range of about 26 inches to about 46 inches, wherein the second support is perpendicular to the first support.

12. The weld curtain of claim 4, wherein the first support has a height within a range of about 12 inches to about 32 inches, and wherein the second support has a height within a range of about 12 inches to about 32 inches, wherein the first support and second support are parallel to one another.

13. The weld curtain of claim 1, further comprising:
a connector configured to receive the linear post and adapted to engaged with a leg of the weld table.

14. The weld curtain of claim 13, wherein the connector further comprises:
at least one lug of a bracket; and
an aperture defined in the at least one lug of the bracket configured to receive the linear post.

15. The weld curtain of claim 14, wherein the bracket further comprises:
a main body operably engaging with the bracket and being generally L-shaped; and
a corner bracket operably engaged with the main body and adapted to receive a corner of the leg of the weld table.

16. A method of assembling a weld curtain comprising:
inserting a first support, into a first sleeve of the screen, the first support having a first end and a second end;
inserting a second support into a second sleeve of the screen, the second support having a first end and a second end;
engaging a dowel with the second end of the first support; and
inserting the dowel into an opening on a weld table, wherein the weld curtain is fully supported by the dowel.

17. The method of claim 16, wherein the steps of inserting the first support into the first sleeve and inserting the second support into the second support further include that the first support and the second support are oriented parallel to one another or oriented perpendicular to one another.

18. The method of claim 16, further comprising:
inserting a third support into a third sleeve of the screen;
engaging the first end of the first support with the third support inside of a channel of the third support; and
engaging the first end of the second support with the third support inside of the channel of the third support;
engaging a fourth support to the second end of the first support; and
engaging the fourth support to the second end of the second support.

19. The method of claim 16, further comprising:
rotating the weld curtain, by the dowel, about a rotational axis defined along a length of the dowel when the dowel is inserted into the opening of the weld table.

20. A method of assembling a weld curtain comprising:
inserting a first support, into a first sleeve of the screen, the first support having a first end and a second end;
inserting a second support into a second sleeve of the screen, the second support having a first end and a second end, wherein the second end further comprises an extension;
engaging a first end of the connector with a leg of the weld table;
engaging the extension with a second end of the connector; and
rotating the weld curtain, by the extension, about a rotational axis defined along the length of the extension relative to the weld table.

21. The method of claim 20, further comprising:
inserting the extension into an aperture of at least one lug of a bracket of the connector.

22. The method of claim 20, further comprising:
engaging a corner bracket of the connector with a leg of the weld table.

23. The method of claim 20, further comprising:
engaging a bolt with the extension and the connector so that the bolt and extension are fixedly engaged.
